(19) United States
(12) Patent Application Publication
(10) Pub. No.: US 2025/0252781 A1
(43) Pub. Date: Aug. 7, 2025

(54) DYNAMIC FACIAL EXPRESSION RECOGNITION METHOD AND APPARATUS, DEVICE, AND STORAGE MEDIUM

(71) Applicant: Tencent Technology (Shenzhen) Company Limited, Shenzhen (CN)

(72) Inventors: Bo LI, Shenzhen (CN); Hanyang WANG, Shenzhen (CN); Shuang WU, Shenzhen (CN); Shouhong DING, Shenzhen (CN)

(73) Assignee: Tencent Technology (Shenzhen) Company Limited, Shenzhen (CN)

(21) Appl. No.: 19/190,369

(22) Filed: Apr. 25, 2025

Related U.S. Application Data
(63) Continuation of application No. PCT/CN2024/076626, filed on Feb. 7, 2024.

(30) Foreign Application Priority Data
Apr. 7, 2023 (CN) 202310401592.7

(51) Int. Cl. G06V 40/16; G06V 10/26; G06V 10/72; G06V 10/77; G06V 10/82; G06V 20/40; G06V 20/70

(52) U.S. Cl. CPC G06V 40/176; G06V 10/26; G06V 10/72; G06V 10/7715; G06V 10/82; G06V 20/46; G06V 20/49; G06V 20/70; G06V 40/171

(57) ABSTRACT

Embodiments of the present disclosure disclose a dynamic facial expression recognition method, a device, and product. The method includes: segmenting a video to be recognized into video segments; extracting and aggregating, for each video segment, features of face image frames in the video segment by using a 3D convolutional network, to obtain target feature data of the video segment; aggregating target feature data of the plurality of video segments, to obtain target feature data of the video to be recognized; and determining an expression label of the video to be recognized based on the target feature data of the video to be recognized, to obtain an expression label recognition result of the video to be recognized.

### RELATED APPLICATION

This application is a continuation of and claims the benefit of priority to PCT International Patent Application No. PCT/CN2024/076626, filed on Feb. 7, 2024, which is based on and claims the benefit of priority to Chinese Patent Application No. 2023104015927, filed with the China National Intellectual Property Administration on Apr. 7, 2023, both entitled “FACIAL EXPRESSION RECOGNITION METHOD AND APPARATUS, DEVICE, AND MEDIUM.” These applications are incorporated herein by reference in their entireties.

### FIELD OF THE TECHNOLOGY

The present disclosure relates to the field of computer technologies, specifically to a dynamic facial expression recognition method and apparatus, an electronic device, and a computer-readable medium.

### BACKGROUND OF THE DISCLOSURE

Facial expression recognition is an important research direction in fields such as computer vision, human-computer interaction, and pattern recognition. It has attracted wide attention of researchers at home and abroad. An image-based facial expression recognition method includes limited expression information and therefore is susceptible to factors such as the external environment or individual differences. In addition, with the rapid development of computer technologies in recent years, video-based dynamic facial expression recognition has gained more attention.

### SUMMARY

Embodiments of the present disclosure provide a dynamic facial expression recognition method and apparatus, a device, and a storage medium.

An embodiment of the present disclosure provides a dynamic facial expression recognition method. The method includes: segmenting a video to be recognized into a plurality of video segments, each video segment including at least one face image frame; extracting and aggregating, for each video segment, features of face image frames in the video segment by using a 3D convolutional network, to obtain target feature data of the video segment, the target feature data of the video segment includes a time series relationship between the face image frames; aggregating target feature data of the plurality of video segments, to obtain target feature data of the video to be recognized, the target feature data of the video to be recognized includes a time series relationship between the plurality of video segments; and determining an expression label of the video to be recognized based on the target feature data of the video to be recognized, to obtain an expression label recognition result of the video to be recognized, the expression label recognition result being used by a video server for video distribution and search.

An embodiment of the present disclosure provides a dynamic facial expression recognition apparatus. The apparatus includes: a segmentation processing module, configured to segment a video to be recognized into a plurality of video segments, each video segment including at least one face image frame; a first aggregation module, configured to: extract and aggregate, for each video segment, features of face image frames in the video segment by using a 3D convolutional network, to obtain target feature data of the video segment, the target feature data of the video segment including a time series relationship between the face image frames; a second aggregation module, configured to aggregate target feature data of the plurality of video segments, to obtain target feature data of the video to be recognized, the target feature data of the video to be recognized including a time series relationship between the plurality of video segments; and a recognition module, configured to determine an expression label of the video to be recognized based on the target feature data of the video to be recognized, to obtain an expression label recognition result of the video to be recognized, the expression label recognition result being used by a video server for video distribution and search.

An embodiment of the present disclosure provides an electronic device. The electronic device includes one or more processors; and a memory, configured to store one or more programs, the one or more programs, when executed by the one or more processors, causing the electronic device to implement the foregoing dynamic facial expression recognition method.

An embodiment of the present disclosure provides a non-transitory computer-readable medium. The computer-readable medium has a computer program stored therein, the computer program, when executed by a processor, causing the foregoing dynamic facial expression recognition method to be implemented.

An embodiment of the present disclosure provides a computer program product. The computer program product includes computer instructions, the computer instructions, when executed by a processor, causing the foregoing dynamic facial expression recognition method to be implemented.

The foregoing general descriptions and the following detailed descriptions are merely for illustration and explanation purposes and are not intended to limit the present disclosure.

### BRIEF DESCRIPTION OF THE DRAWINGS

FIG. 1 is a schematic diagram of an exemplary implementation environment in which a technical solution of embodiments of the present disclosure may be applied.

FIG. 2 is a flowchart of a dynamic facial expression recognition method according to some example embodiments of the present disclosure.

FIG. 3 is another flowchart of a dynamic facial expression recognition method according to some other example embodiments of the present disclosure.

FIG. 4 is another flowchart of a dynamic facial expression recognition method according to some example embodiments of the present disclosure.

FIG. 5 is another flowchart of a dynamic facial expression recognition method according to some example embodiments of the present disclosure.

FIG. 6 is another flowchart of a dynamic facial expression recognition method according to some example embodiments of the present disclosure.

FIG. 7 is another flowchart of a dynamic facial expression recognition method according to some example embodiments of the present disclosure.

FIG. 8 is another flowchart of a dynamic facial expression recognition method according to some example embodiments of the present disclosure.

FIG. 9 is another flowchart of a dynamic facial expression recognition method according to some example embodiments of the present disclosure.

FIG. 10 is another flowchart of a dynamic facial expression recognition method according to some example embodiments of the present disclosure.

FIG. 11 is another flowchart of a dynamic facial expression recognition method according to some example embodiments of the present disclosure.

FIG. 12 is another flowchart of a dynamic facial expression recognition method according to some example embodiments of the present disclosure.

FIG. 13 is a schematic diagram of a dynamic facial expression recognition method according to some example embodiments of the present disclosure.

FIG. 14 is a schematic diagram of a long time series dynamic instance aggregation module according to some example embodiments of the present disclosure.

FIG. 15 is a schematic diagram of a multi-instance dynamic regularization network according to some example embodiments of the present disclosure.

FIG. 16 is a block diagram of a dynamic facial expression recognition apparatus according to some example embodiments of the present disclosure.

FIG. 17 is an example schematic structural diagram of a computer system of an electronic device suitable for implementing the embodiments of the present disclosure.

### DESCRIPTION OF EMBODIMENTS

Exemplary embodiments are described in detail herein, and examples of the exemplary embodiments are shown in the accompanying drawings. When the following descriptions relate to the accompanying drawings, unless otherwise indicated, same numbers in different accompanying drawings represent same or similar elements. The implementations described in the following exemplary embodiments do not represent all implementations the same as the present disclosure. On the contrary, the implementations are merely examples of apparatuses and methods that are the same as those in some aspects of the present disclosure and that are described in detail in the appended claims.

The block diagrams shown in the accompany drawings are merely functional entities and do not definitely correspond to physically independent entities. That is, the functional entities may be implemented in a software form, or in one or more hardware modules or integrated circuits, or in different networks and/or processor apparatuses and/or microcontroller apparatuses.

The flowcharts shown in the accompanying drawings are merely examples for descriptions, do not definitely include all content and operations/steps, and are not definitely performed in the described sequences. For example, some operations/blocks may be further divided, while some operations/blocks may be combined or partially combined. Therefore, an actual execution sequence may change according to an actual case.

“Plurality of” mentioned in the present disclosure means two or more. “And/or” describes an association relationship for describing associated objects and represents that three relationships may exist. For example, A and/or B may represent the following three cases: Only A exists, both A and B exist, and only B exists. The character “/” generally indicates an “or” relationship between the associated objects.

Facial expression recognition is an important research direction in the fields such as computer vision, human-computer interaction, and pattern recognition, and has attracted wide attention of researchers at home and abroad. An image-based facial expression recognition method includes limited expression information and therefore are susceptible to factors such as an external environment and individual differences. In addition, with the rapid development of computer technologies in recent years, video-based dynamic facial expression recognition has gained more attention.

Currently, during video-based dynamic facial expression recognition, an object may have facial movements such as speaking. Although these facial movements usually have slight differences, the facial movements may affect the accuracy of facial expression recognition to some extent.

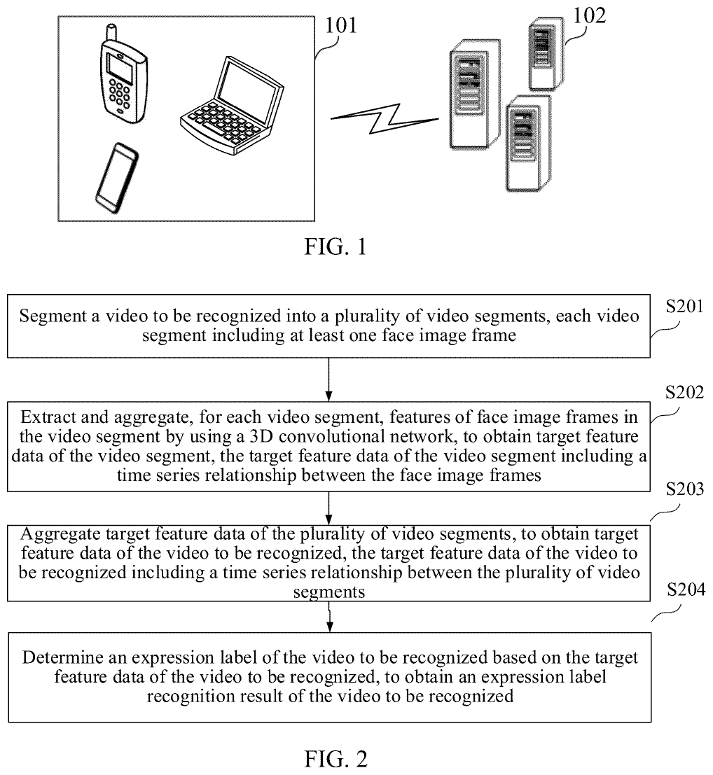

Therefore, to improve the accuracy of facial expression recognition, the present disclosure provides a dynamic facial expression recognition solution. FIG. 1 is a schematic diagram of an implementation environment according to the present disclosure. The implementation environment mainly includes a terminal device 101 and a server 102. The terminal device 101 and the server 102 may communicate with each other by using a wired or wireless network.

The terminal device 101 includes, but is not limited to, a smartphone, a tablet, a notebook computer, a computer, an intelligent voice interaction device, an intelligent home appliance, an in-vehicle terminal, an aircraft, and the like.

The server 102 may be a server providing various services. The server 102 may be an independent physical server, or may be a server cluster including a plurality of physical servers or a distributed system, or may be a cloud server that provides basic cloud computing services such as a cloud service, a cloud database, cloud computing, a cloud function, cloud storage, a network service, cloud communication, a middleware service, a domain name service, a security service, a content delivery network (CDN), big data, and an artificial intelligence platform, but is not limited thereto.

Quantities of terminal devices 101 and servers 102 in FIG. 1 are merely exemplary, and there may be any quantity of terminal devices 101 and servers 102 according to an actual requirement.

In some embodiments of the present disclosure, a dynamic facial expression recognition method may be jointly performed by the terminal device 101 and the server 102.

For example, the terminal device 101 captures a video to be recognized, and sends the video to be recognized to the server 102. Correspondingly, the server 102 receives the video to be recognized sent by the terminal device 101, and segments the video to be recognized, to obtain a plurality of video segments; performs, based on face image frames included in each video segment, aggregation processing on features between the face image frames, to obtain target feature data of each video segment; performs aggregation processing on features between the video segments based on target feature data of the plurality of video segments, to obtain target feature data of the video to be recognized; and recognizes an expression label of the video to be recognized based on the target feature data of the video to be recognized, to obtain an expression label recognition result of the video to be recognized.

The dynamic facial expression recognition method may alternatively be performed by the terminal device 101 alone, or may be performed by the server 102 alone. In actual application, flexible adjustment may be performed according to a specific application scenario.

The technical solution of the embodiment shown in FIG. 1 may be applied to various scenarios.

For example, if the technical solution is applied to a scenario involving entertainment such as live streaming, by implementing the solution of this embodiment of the present disclosure, a facial expression of a live streamer included in a live streaming video can be accurately recognized, thereby improving the live streaming experience of a related user, and the like.

For example, if the technical solution is applied to a scenario involving Internet of Vehicles such as driving, by implementing the solution of this embodiment of the present disclosure, a facial expression of a driver included in a transmitted video can be accurately recognized, thereby improving the road safety, and the like.

For example, if the technical solution is applied to a management scenario involving area management such as a garage or a store, by implementing the solution of this embodiment of the present disclosure, a facial expression of an entering and leaving person included in a management video can be accurately recognized, thereby improving the accuracy of area management, ensuring the safety of related items, and the like.

In specific implementations of the present disclosure, data related to a user is involved. When the following embodiments of the present disclosure are applied to a specific product or technology, user permission or consent needs to be obtained, and collection, use, and processing of the related data need to comply with related laws and regulations and standards of related countries and regions.

The following describes various implementation details of the technical solutions of the embodiments of the present disclosure in detail.

FIG. 2 is a flowchart of a dynamic facial expression recognition method according to some embodiments of the present disclosure. The dynamic facial expression recognition method may be performed by the server 102. As shown in FIG. 2, the dynamic facial expression recognition method includes at least S201 to S204, which are described in detail as follows.

S201: Segment a video to be recognized into a plurality of video segments, each video segment including at least one face image frame.

The video to be recognized in this embodiment of the present disclosure is a video that requires facial expression recognition. In some embodiments, the at least one face image frame corresponds to a continuous facial movement.

The video to be recognized in this embodiment of the present disclosure may be a video generated in any scenario. For example, the video to be recognized may be a video generated by a live streaming terminal in a live streaming scenario, or may be a video generated by an in-vehicle terminal in an Internet of Vehicles scenario, or may be a video generated by a camera in a management scenario of a specific area. In actual application, the video to be recognized may be flexibly adjusted according to a specific application scenario.

In some related arts, a video is generally segmented into different segments by frame. However, for a dynamic expression, when an object is speaking, some individual frames cannot form a normal facial expression. From the perspective of only one frame, these frames are abnormal, and actually represent a process of facial movements. In addition, these facial movements and inter-class differences are slight, resulting in even small movements causing changes in extracted features and predicted expressions during classification.

In this embodiment of the present disclosure, after obtaining the video to be recognized, the server may segment the video to be recognized, to obtain a plurality of video segments. Each video segment can include a continuous facial movement, to correspondingly prepare for subsequent facial expression recognition of the video to be recognized. The video to be recognized and the plurality of video segments are in a one-to-many relationship, that is, one video to be recognized is segmented into a plurality of video segments. For example, the video to be recognized is represented by V, and the video to be recognized V may be segmented into N video segments, where N≥2 and N is an integer.

In this embodiment of the present disclosure, the video to be recognized is segmented, and each of the plurality of obtained video segments includes an image frame including a face, that is, each video segment includes at least one image frame including a face. The image frame including a face is referred to as a face image frame below. A quantity of face image frames included in each video segment may be the same or may be different. In actual application, the quantity of face image frames included in each video segment may be flexibly adjusted according to a specific application scenario.

S202: Extract and aggregate, for each video segment, features of face image frames in the video segment by using a 3D convolutional network, to obtain target feature data of the video segment, the target feature data of the video segment including a time series relationship between the face image frames.

In this embodiment of the present disclosure, after segmenting the video to be recognized, to obtain the plurality of video segments, the server may perform aggregation processing on the features between the face image frames based on the face image frames included in each video segment, to obtain target feature data of each video segment.

In some embodiments, the 3D convolutional network may be a residual 3D (R3D) network, which includes a series of 3D convolutional layers, maximum pooling layers, and fully connected layers, to capture a spatio-temporal relationship between video frames, thereby implementing movement recognition.

The time series relationship between the face image frames, or referred to as a short-term time series relationship, refers to a short-term dependency relationship between the face image frames in the video segment. A temporal dependency between the face image frames can be captured by using a temporal convolutional layer of the 3D convolutional network.

In this embodiment of the present disclosure, the target feature data of each video segment means that each video segment has its corresponding target feature data. The target feature data corresponding to the video segment refers to feature data obtained after aggregation processing is performed on the features corresponding to face image frames included in the video segment.

For example, still using the foregoing example, it is assumed that N=5, that is, there are five video segments, and the five video segments are respectively I₁-I₅. Using the video segment I₁ as an example, it is assumed that the video segment I₁ includes 300 face image frames, and aggregation processing is performed on features corresponding to the 300 face image frames included in the video segment I₁, to obtain target feature data of the video segment I₁. By analogy, target feature data respectively corresponding to the other video segments I₂-I₅ can be obtained. Details are not described herein again.

In some implementations of the present disclosure, S202 may include:
respectively extracting the features of the face image frames in the video segment by using the 3D convolutional network, to obtain image features of each face image frame;
sequentially inputting, for any video segment, the face image frames included in the video segment into the 3D convolutional network in sequence; and
extracting and aggregating the features of the plurality of face image frames by using the 3D convolutional network, to obtain the target feature data of the video segment.

The extracting and aggregating the features of the plurality of face image frames by using the 3D convolutional network, to obtain the target feature data of the video segment includes:
sequentially extracting three-dimensional feature data of the plurality of face image frames; and
splicing the extracted three-dimensional feature data in sequence, to obtain the target feature data of the video segment.

That is, the server first extracts the features of the face image frames included in each video segment, to obtain the image features of each video segment, and then performs, for each video segment, aggregation processing on the image features corresponding to the video segment, to obtain the target feature data of the video segment.

For example, still using the foregoing example, the video segment I₁ is used as an example. First, the features of the 300 frames included in the video segment I₁ are extracted, and it is assumed that the extracted image features F′ are [f1, f2, f3, . . . , f298, f299, f300]. Then, aggregation processing is performed on [f1, f2, f3, . . . , f298, f299, f300], to obtain target feature data F₁ of the video segment I₁. By analogy, target feature data F₂-F₅ respectively corresponding to the other video segments I₂-I₅ can be obtained. Details are not described herein again.

In S202, starting from the fine granularity dimension of the face image frame, aggregation processing is performed on the features corresponding to the face image frames included in the video segment, to establish an association between the face image frames in the video segment, that is, establish an association between the face image frames inside the video segment, to obtain more accurate target feature data of the video segment.

S203: Aggregate target feature data of the plurality of video segments, to obtain target feature data of the video to be recognized, the target feature data of the video to be recognized including a time series relationship between the plurality of video segments.

In this embodiment of the present disclosure, after performing aggregation processing on the features between the face image frames based on the face image frames included in each video segment, to obtain the target feature data of each video segment, the server may perform aggregation processing on the features between the video segments based on the target feature data of the plurality of video segments, to obtain the target feature data of the video to be recognized.

In this embodiment of the present disclosure, the target feature data of the video to be recognized refers to feature data obtained after aggregation processing is performed on the target feature data of the plurality of video segments.

For example, still using the foregoing example, assuming that the target feature data respectively corresponding to the video segments I₂-I₅ is F₁-F₅, aggregation processing is performed on the target feature data F₁-F₅ respectively corresponding to the video segments I₂-I₅, to obtain target feature data F of the video to be recognized V.

In S203, starting from the coarse granularity dimension of the video segment, aggregation processing is performed on the target feature data corresponding to the plurality of video segments included in the video to be recognized, to establish an association between the video segments in the video to be recognized, that is, establish an association between the video segments inside the video to be recognized, to obtain more accurate target feature data of the video to be recognized.

S204: Determine an expression label of the video to be recognized based on the target feature data of the video to be recognized, to obtain an expression label recognition result of the video to be recognized.

In this embodiment of the present disclosure, after performing aggregation processing on the features between the video segments based on the target feature data of the plurality of video segments, to obtain the target feature data of the video to be recognized, the server may recognize, based on the target feature data of the video to be recognized, the expression label of the video to be recognized, to obtain the expression label recognition result of the video to be recognized. The expression label recognition result is used by a video server for video distribution and search.

In this embodiment of the present disclosure, the expression label recognition result of the video to be recognized is an expression label of the video to be recognized. The expression label includes, but is not limited to, a joy label, a sadness label, an anger label, a panic label, a disgust label, and the like. In actual application, the expression label may be flexibly adjusted according to a specific application scenario.

For example, the video to be recognized may have one expression label, such as any one of the joy label, the sadness label, the anger label, the panic label, or the disgust label.

For example, the video to be recognized may have a plurality of expression labels, such as any two or more of the joy label, the sadness label, the anger label, the panic label, or the disgust label.

In this embodiment of the present disclosure, the server establishes a short-term time series association between the face image frames and a long-term time series association between the video segments by starting from the fine granularity dimension of the face image frame and the coarse granularity dimension of the video segment simultaneously, thereby reducing the impact caused by facial movements of the object on feature data, and starting from overall features of the video to be recognized as much as possible, so that the obtained target feature data of the video to be recognized is more accurate. Further, the expression label of the video to be recognized is determined based on the more accurate target feature data of the video to be recognized, so that a more accurate expression label recognition result of the video to be recognized can be obtained, thereby improving the accuracy of facial expression recognition.

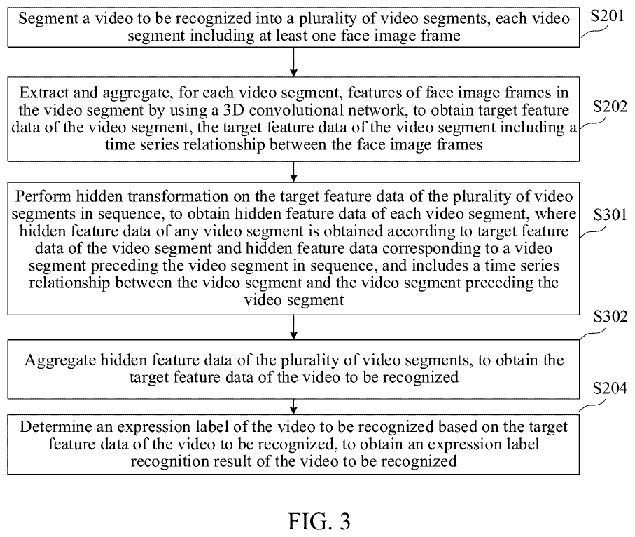

In some embodiments of the present disclosure, another dynamic facial expression recognition method is provided. The dynamic facial expression recognition method may be performed by the server 102. As shown in FIG. 3, the dynamic facial expression recognition method may include S301 to S302, S201 to S202, and S204.

S301 to S302 are described in detail as follows.

S301: Perform hidden transformation on the target feature data of the plurality of video segments in sequence, to obtain hidden feature data of each video segment, where
hidden feature data of any video segment is obtained according to target feature data of the video segment and hidden feature data corresponding to a video segment preceding the video segment in sequence, and includes a time series relationship between the video segment and the video segment preceding the video segment.

In this embodiment of the present disclosure, the sequence refers to a chronological sequence of the plurality of video segments. Correspondingly, the time series relationship refers to a chronological relationship of the plurality of video segment.

For example, still using the foregoing example, it is assumed that the video to be recognized Vis a 25-second video segment from 09:00:00 to 09:00:25, the video to be recognized Vis sequentially segmented into 5 video segments in sequence, and the 5 video segments are respectively video segments I₁-I₅. The video segment I₁ corresponds to 09:00:00-09:00:05, the video segment I₂ corresponds to 09:00:05-09:00:10, the video segment I₃ corresponds to 09:00:10-09:00:15, the video segment I₄ corresponds to 09:00:15-09:00:20, and the video segment I₅ corresponds to 09:00:20-09:00:25. Therefore, a sequence or time series relationship between the video segments I₁-I₅ is that the video segment I₁ is the video segment of the first 5 seconds, the video segment I₂ is the adjacent video segment 5 seconds after the video segment I₁, the video segment I₃ is the adjacent video segment 5 seconds after the video segment I₂, the video segment I₄ is the adjacent video segment 5 seconds after the video segment I₃, and the video segment I₅ is the adjacent video segment 5 seconds after the video segment I₄.

Any video segment in the embodiments of the present disclosure refers to each of the plurality of video segments.

For example, still using the foregoing example, the video segment I₁, the video segment I₂, the video segment I₃, the video segment I₄, and the video segment I₅ are any video segment.

A video segment preceding any video segment in this embodiment of the present disclosure refers to a video segment earlier than any video segment.

In some embodiments of the present disclosure, a video segment preceding any video segment may be an adjacent or non-adjacent video segment earlier than any video segment.

For example, still using the foregoing example, assuming that the video segment I₃ is any video segment, an adjacent video segment earlier than the video segment I₃ is the video segment I₂, and a non-adjacent video segment earlier than the video segment I₃ is the video segment I₁. In this case, a video segment preceding the video segment I₃ may be at least one of the video segment I₂ or the video segment I₁.

In some embodiments of the present disclosure, there may be one or more video segments preceding any video segment.

For example, still using the foregoing example, when there is one video segment preceding the video segment I₃, the video segment may be the video segment I₂ or the video segment I₁; and when there are a plurality of video segments preceding the video segment I₃, the video segments may be the video segment I₂ and the video segment I₁.

In this embodiment of the present disclosure, the hidden feature data of any video segment refers to feature data obtained after hidden transformation is performed on target feature data of the video segment based on hidden feature data corresponding to a video segment preceding the video segment.

For example, still using the foregoing example, if a video segment preceding the video segment I₃ is the video segment I₂, hidden transformation is performed on target feature data of the video segment I₃ based on hidden feature data corresponding to the video segment I₂, to obtain hidden feature data of the video segment I₃.

If a video segment preceding the video segment I₂ is the video segment I₁, hidden transformation is performed on target feature data of the video segment I₂ based on hidden feature data corresponding to the video segment I₁, to obtain the hidden feature data of the video segment I₂.

If a video segment preceding the video segment I₃ is the video segment I₁, hidden transformation is performed on the target feature data of the video segment I₃ based on the hidden feature data corresponding to the video segment I₁, to obtain the hidden feature data of the video segment I₃.

Since there is no video segment preceding the video segment I₁, hidden transformation is performed on target feature data of the video segment I₁, to obtain the hidden feature data of the video segment I₁.

If video segments preceding the video segment I₃ are the video segment I₂ and the video segment I₁, hidden transformation is performed on the target feature data of the video segment I₃ based on the hidden feature data corresponding to the video segment I₂ and the hidden feature data corresponding to the video segment I₁, to obtain the hidden feature data of the video segment I₃.

Similarly, processes of obtaining hidden feature data respectively corresponding to the other video segments I₄-I₅ can be deduced by analogy. Details are not described herein again.

The hidden transformation in this embodiment of the present disclosure refers to abstracting the target feature data of the video segment to another dimensional space, to obtain more abstract features, so that these more abstract features can be better used for linear division and the like.

S302: Aggregate hidden feature data of the plurality of video segments, to obtain the target feature data of the video to be recognized.

In this embodiment of the present disclosure, after performing hidden transformation on the target feature data of the plurality of video segments in sequence, to obtain the hidden feature data of each video segment, the server may aggregate the hidden feature data of the plurality of video segments, to obtain the target feature data of the video to be recognized.

That is, in this embodiment of the present disclosure, starting from the coarse granularity dimension of the video segment, specifically, aggregation processing is performed on the hidden feature data corresponding to the plurality of video segments included in the video to be recognized, to establish an accurate association between the video segment in the video to be recognized.

For detailed descriptions of S201 to S202, and S204 shown in FIG. 3, refer to S201 to S202, and S204 shown in FIG. 2. Details are not described herein again.

In this embodiment of the present disclosure, the server captures the association between the video segment by performing hidden transformation on the target feature data of each video segment, so that the obtained target feature data of the video to be recognized is more accurate, thereby more accurately recognizing the expression label of the video to be recognized based on the more accurate target feature data of the video to be recognized, and improving the accuracy of facial expression recognition.

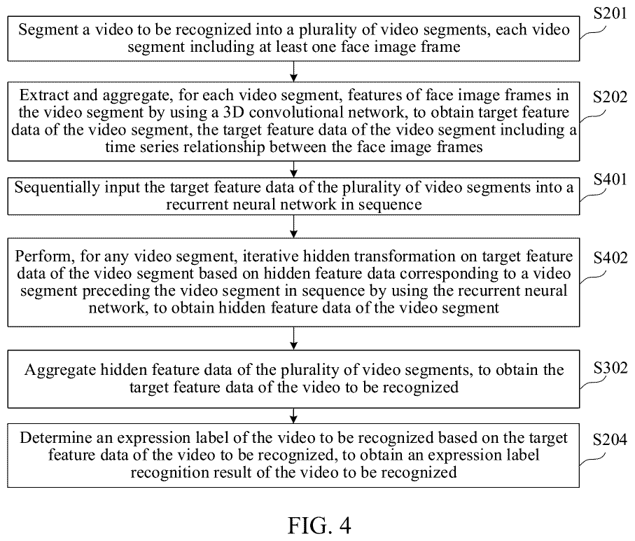

In some embodiments of the present disclosure, another dynamic facial expression recognition method is provided. The dynamic facial expression recognition method may be performed by the server 102. As shown in FIG. 4, the dynamic facial expression recognition method may include S401 to S402, S302, S201 to S202, and S204.

S401 to S402 are described in detail as follows.

S401: Sequentially input the target feature data of the plurality of video segments into a recurrent neural network in sequence.

In the embodiments of the present disclosure, the recurrent neural network (RNN) refers to a network for storing a final output in its own internal memory to memorize a previous state of data. It uses a previous output and a data state, which essentially affects final output data. Its working principle is similar to that of a common layer in a multilayer perceptron, but it uses a state matrix to calculate a new output.

For example, the recurrent neural network may be a long short-term memory (LSTM) network. The long short-term memory network is further extended to store a state matrix as two states (that is, a long-term state and a short-term state). If the state matrix persists in a model output, it is stored as a long-term state matrix, and occupies a larger weight when new data is considered.

S402: Perform, for any video segment, iterative hidden transformation on target feature data of the video segment based on hidden feature data corresponding to a video segment preceding the video segment in sequence by using the recurrent neural network, to obtain hidden feature data of the video segment.

In this embodiment of the present disclosure, the server sequentially inputs the target feature data of the plurality of video segments into the recurrent neural network in sequence, and then may perform iterative hidden transformation on target feature data of a current video segment based on hidden feature data corresponding to a video segment preceding the current video segment in sequence by using the recurrent neural network, to obtain hidden feature data of the current video segment.

For example, still using the foregoing example, for the video segment I₁, the video segment I₁ is inputted into the recurrent neural network, and iterative hidden transformation is performed on the target feature data F₁ corresponding to the video segment I₁ by using the recurrent neural network, to obtain hidden feature data X₁ corresponding to the video segment I₁.

For the video segment I₂, the video segment I₂ is inputted into the recurrent neural network, and iterative hidden transformation is performed on the target feature data F₂ corresponding to the video segment I₂ based on the hidden feature data corresponding to the video segment I₁ preceding the video segment I₂ by using the recurrent neural network, to obtain hidden feature data X₂ corresponding to the video segment I₂.

For the video segment I₃, the video segment I₃ is inputted into the recurrent neural network, and iterative hidden transformation is performed on the target feature data F₃ corresponding to the video segment I₃ based on the hidden feature data corresponding to the video segment I₂ preceding the video segment I₃ by using the recurrent neural network, to obtain hidden feature data X₃ corresponding to the video segment I₃.

For the video segment I₄, the video segment I₄ is inputted into the recurrent neural network, and iterative hidden transformation is performed on the target feature data F₄ corresponding to the video segment I₄ based on the hidden feature data corresponding to the video segment I₃ preceding the video segment I₄ by using the recurrent neural network, to obtain hidden feature data X₄ corresponding to the video segment I₄.

For the video segment I₅, the video segment I₅ is inputted into the recurrent neural network, and iterative hidden transformation is performed on the target feature data F₅ corresponding to the video segment I₅ based on the hidden feature data corresponding to the video segment I₄ preceding the video segment I₅ by using the recurrent neural network, to obtain hidden feature data X₅ corresponding to the video segment I₅.

For detailed descriptions of S302 shown in FIG. 4, refer to S302 shown in FIG. 3. For detailed descriptions of S201 to S202, and S204 shown in FIG. 4, refer to S201 to S202, and S204 shown in FIG. 2. Details are not described herein again.

In this embodiment of the present disclosure, the server performs iterative hidden transformation on the target feature data of any video segment by using the recurrent neural network, to obtain the hidden feature data of the video segment. In this way, the long-term time series association between the video segments is quickly established, and the process is simple and easy to implement.

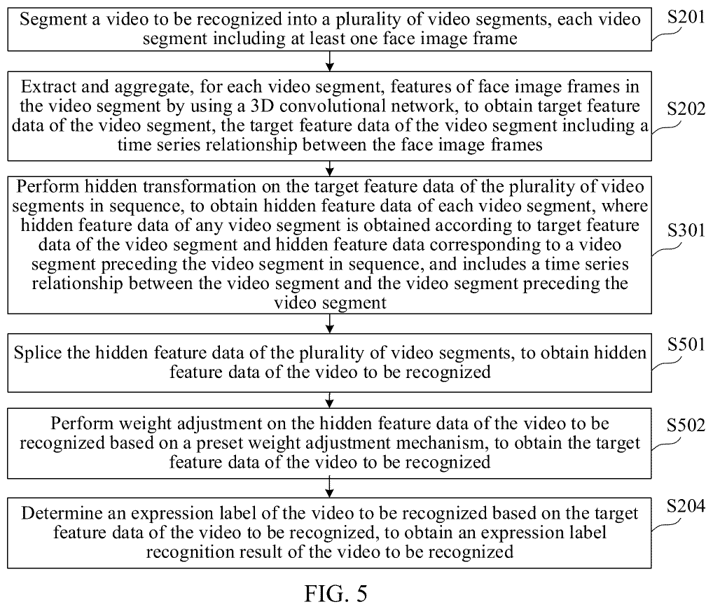

In some embodiments of the present disclosure, another dynamic facial expression recognition method is provided. The dynamic facial expression recognition method may be performed by the server 102. As shown in FIG. 5, the dynamic facial expression recognition method may include S501 to S502, S301, S201 to S202, and S204.

S501: Splice the hidden feature data of the plurality of video segments, to obtain hidden feature data of the video to be recognized.

In this embodiment of the present disclosure, after sequentially performing hidden transformation on the target feature data of the plurality of video segments, to obtain the hidden feature data of each video segment, the server may splice the hidden feature data of the plurality of video segments, to obtain the hidden feature data of the video to be recognized.

For example, still using the foregoing example, assuming that the hidden feature data respectively corresponding to the video segments I₁-I₅ is X₁-X₅, the hidden feature data X₁-X₅ is spliced, to obtain hidden feature data X of the video to be recognized.

In some embodiments of the present disclosure, the process of splicing the hidden feature data of the plurality of video segments, to obtain hidden feature data of the video to be recognized in S501 may include: splicing the hidden feature data of the plurality of video segments in sequence, to obtain the hidden feature data of the video to be recognized.

For example, still using the foregoing example, splicing may be performed according to a sequence of X₁, X₂, X₃, X₄, and X₅, that is, X₁+X₂+X₃+X₄+X₅, to obtain the hidden feature data of the video to be recognized V.

The hidden feature data of the plurality of video segments is spliced in sequence, so that more associations between the video segments can be captured.

In other embodiments, the server may further randomly splice the hidden feature data of the plurality of video segments (that is, splice the hidden feature data of the plurality of video segments out of sequence). In actual application, splicing the hidden feature data of the plurality of video segments may be flexibly adjusted according to a specific application scenario.

The hidden feature data of the plurality of video segments is randomly spliced, so that the splicing efficiency is higher, and the hidden feature data of the video to be recognized can be quickly obtained.

S502: Perform weight adjustment on the hidden feature data of the video to be recognized based on a preset weight adjustment mechanism, to obtain the target feature data of the video to be recognized.

In this embodiment of the present disclosure, after splicing the hidden feature data of the plurality of video segments, to obtain the hidden feature data of the video to be recognized, the server may perform weight adjustment on the hidden feature data of the video to be recognized based on the preset weight adjustment mechanism, to obtain the target feature data of the video to be recognized.

In this embodiment of the present disclosure, the preset weight adjustment mechanism is a mechanism preset for weight adjustment on the hidden feature data of the video to be recognized. In actual application, the preset weight adjustment mechanism may be flexibly adjusted according to a specific application scenario.

That is, in this embodiment of the present disclosure, starting from the coarse granularity dimension of the video segment, after aggregation processing is performed on the hidden feature data corresponding to the plurality of video segments included in the video to be recognized, weight adjustment is further performed on aggregated hidden feature data of the video to be recognized, to establish a more accurate association between the video segments in the video to be recognized.

For detailed descriptions of S301 shown in FIG. 5, refer to S301 shown in FIG. 3. For detailed descriptions of S201 to S202, and S204 shown in FIG. 5, refer to S201 to S202, and S204 shown in FIG. 2. Details are not described herein again.

In this embodiment of the present disclosure, the server splices the hidden feature data of the plurality of video segments, thereby implementing quick aggregation processing on the hidden feature data between the video segments. The process is simple and easy to implement. In addition, weight adjustment is performed on the hidden feature data of the video to be recognized, so that more accurate target feature data of the video to be recognized can be obtained, thereby more accurately recognizing the expression label of the video to be recognized based on the more accurate target feature data of the video to be recognized, and further improving the accuracy of facial expression recognition.

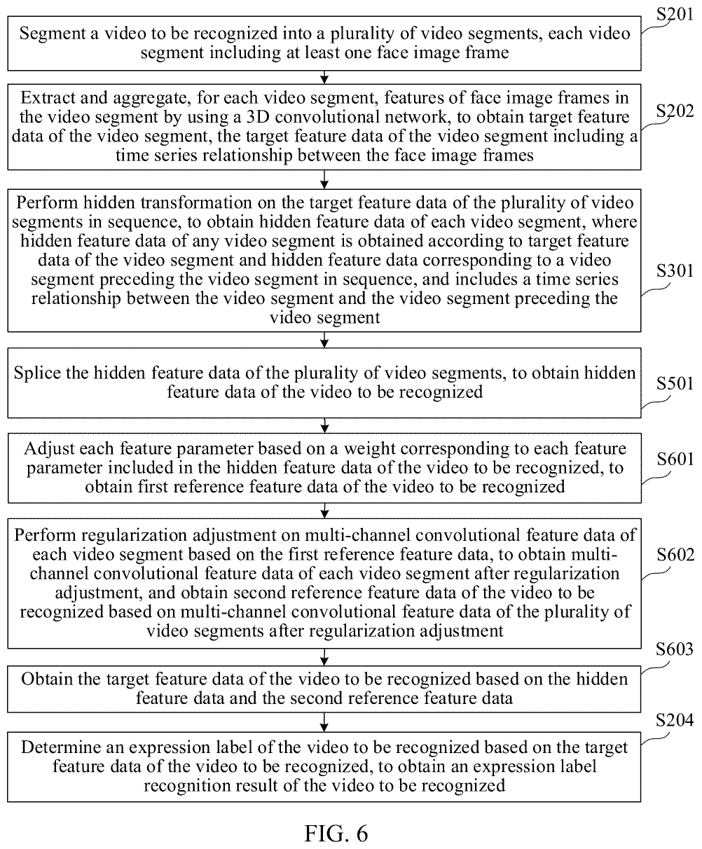

In some embodiments of the present disclosure, another dynamic facial expression recognition method is provided. The dynamic facial expression recognition method may be performed by the server 102. As shown in FIG. 6, the dynamic facial expression recognition method may include S601 to S603, S501, S301, S201 to S202, and S204.

In this embodiment of the present disclosure, the hidden feature data of the video to be recognized includes a plurality of feature parameters. For example, the hidden feature data of the video to be recognized may be a hidden feature matrix, that is, the hidden feature data of the video to be recognized is represented based on a matrix. The matrix includes rows and columns. Generally, a quantity of the rows is greater than 1, and a quantity of the columns is greater than 1, that is, the hidden feature matrix includes a plurality of feature parameters.

S601 to S603 are described in detail as follows.

S601: Adjust each feature parameter included in the hidden feature data of the video to be recognized based on a weight corresponding to each feature parameter, to obtain first reference feature data of the video to be recognized.

In this embodiment of the present disclosure, the weight corresponding to each feature parameter means that each feature parameter has its corresponding weight, and the weight may be preset.

In this embodiment of the present disclosure, the first reference feature data of the video to be recognized is data obtained after weight adjustment is performed on each feature parameter included in the hidden feature data of the video to be recognized.

In this embodiment of the present disclosure, after obtains the hidden feature data of the video to be recognized, the server may adjust each feature parameter based on the weight corresponding to each feature parameter included in the hidden feature data, to obtain the first reference feature data of the video to be recognized.

S602: Perform regularization adjustment on multi-channel convolutional feature data of each video segment based on the first reference feature data, to obtain multi-channel convolutional feature data of each video segment after regularization adjustment, and obtain second reference feature data of the video to be recognized based on multi-channel convolutional feature data of the plurality of video segments after regularization adjustment.

In this embodiment of the present disclosure, the multi-channel convolutional feature data of each video segment means that each video segment has its corresponding multi-channel convolutional feature data. The multi-channel convolutional feature data corresponding to the video segment is feature data obtained after multi-channel convolution processing is performed on the target feature data of the video segment.

In this embodiment of the present disclosure, the channel is a channel in a multi-head attention mechanism.

In this embodiment of the present disclosure, regularization adjustment refers to restricting the multi-channel convolutional feature data, to prevent it from getting out of control, and reducing the degree of dependency on data to prevent overfitting.

In this embodiment of the present disclosure, the second reference feature data of the video to be recognized is data obtained after aggregation processing is performed on the multi-channel convolutional feature data of the plurality of video segments after regularization adjustment.

In this embodiment of the present disclosure, after obtaining the first reference feature data of the video to be recognized, the server may perform regularization adjustment on the multi-channel convolutional feature data of each video segment based on the first reference feature data, to obtain the multi-channel convolutional feature data of each video segment after regularization adjustment, and obtain the second reference feature data of the video to be recognized based on the multi-channel convolutional feature data of the plurality of video segments after regularization adjustment.

S603: Obtain the target feature data of the video to be recognized based on the hidden feature data and the second reference feature data.

In this embodiment of the present disclosure, after obtaining the second reference feature data of the video to be recognized, the server may use the hidden feature data and the second reference feature data of the video to be recognized as the target feature data of the video to be recognized.

S601 and S602 shown in FIG. 6 may be performed simultaneously, or may be performed sequentially. In addition, for detailed descriptions of S501 shown in FIG. 6, refer to S501 shown in FIG. 5. For detailed descriptions of S301 shown in FIG. 6, refer to S301 shown in FIG. 3. For detailed descriptions of S201 to S202, and S204 shown in FIG. 6, refer to S201 to S202, and S204 shown in FIG. 2. Details are not described herein again.

In this embodiment of the present disclosure, the server simultaneously performs weight adjustment on the hidden feature data of the video to be recognized, to obtain the first reference feature data of the video to be recognized, and performs regularization adjustment on the multi-channel convolutional feature data of each video segment in the video to be recognized based on the first reference feature data of the video to be recognized, to obtain the second reference feature data of the video to be recognized, so that the target feature data of the video to be recognized that is obtained based on the hidden feature data and the second reference feature data is more accurate.

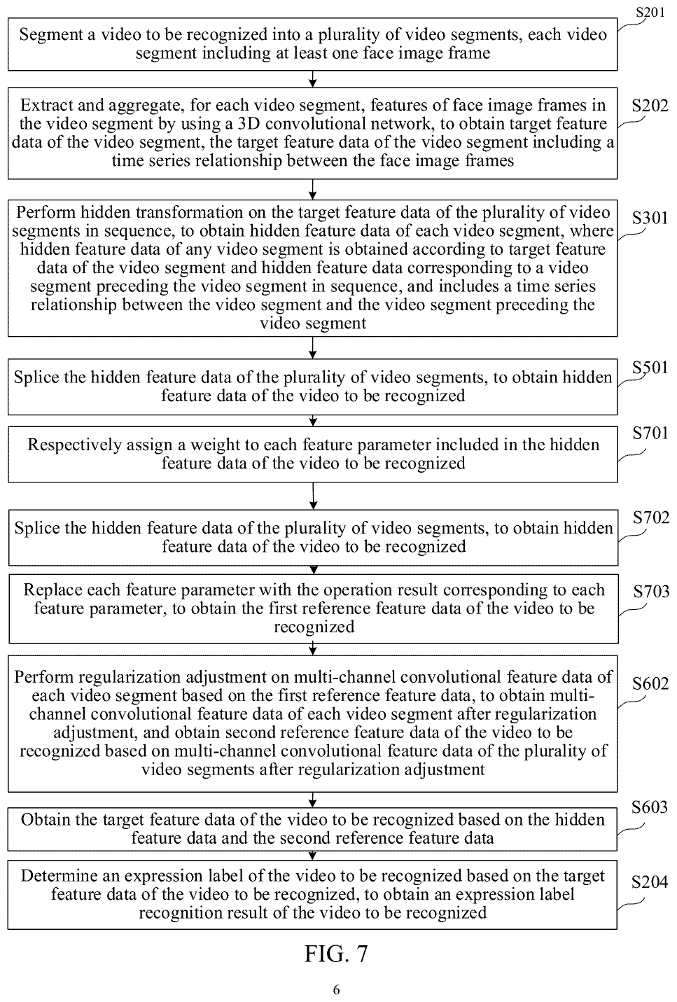

In some embodiments of the present disclosure, another dynamic facial expression recognition method is provided. The dynamic facial expression recognition method may be performed by the server 102. As shown in FIG. 7, the dynamic facial expression recognition method may include S701 to S703, S602, S603, S501, S301, S201 to S202, and S204.

S701 to S703 are described in detail as follows.

S701: Respectively assign a weight to each feature parameter included in the hidden feature data of the video to be recognized.

In this embodiment of the present disclosure, the server may assign a corresponding weight to each feature parameter based on importance of each feature parameter included in the hidden feature data.

For example, the hidden feature data of the video to be recognized is represented by X, and it is assumed that the feature parameters included in the hidden feature data X are x11, x12, x21, and x22 respectively, that is

$$X = [ \begin{matrix}x 11 & x 12 \\ x 21 & x 22\end{matrix} ] .$$

In this case, corresponding weights are respectively assigned to the feature parameters x11, x12, x21, and x22.

S702: Perform a multiplication operation on each feature parameter and the weight corresponding to each feature parameter, to obtain an operation result corresponding to each feature parameter.

In this embodiment of the present disclosure, after assigning a corresponding weight to each feature parameter based on importance of each feature parameter included in the hidden feature data of the video to be recognized, the server may perform the multiplication operation on each feature parameter and the weight corresponding to each feature parameter, to obtain the operation result corresponding to each feature parameter.

For example, still using the foregoing example, if weights respectively corresponding to the feature parameters x11, x12, x21, and x22 are p11, p12, p21, and p22, the following operations: p11*x11, p12*x12, p21*x21, and p22*x22, are performed to obtain an operation result p11*x11 corresponding to the feature parameter x11, an operation result p12*x12 corresponding to the feature parameter x12, an operation result corresponding to the feature parameter, an operation result p21*x21 corresponding to the feature parameter x21, and an operation result p22*x22 corresponding to the feature parameter x22.

S703: Replace each feature parameter with the operation result corresponding to each feature parameter, to obtain the first reference feature data of the video to be recognized.

In this embodiment of the present disclosure, after performing the multiplication operation on each feature parameter and the weight corresponding to each feature parameter, to obtain the operation result corresponding to each feature parameter, the server may replace each feature parameter with the operation result corresponding to each feature parameter, to obtain the first reference feature data of the video to be recognized.

For example, still using the foregoing example, the feature parameter x11 is replaced with the operation result p11*x11 corresponding to the feature parameter x11, the feature parameter x12 is replaced with the operation result p12*x12 corresponding to the feature parameter x12, the feature parameter x21 is replaced with the operation result p21*x21 corresponding to the feature parameter x21, and the feature parameter x22 is replaced with the operation result p22*x22 corresponding to the feature parameter x22, to obtain first reference feature data A of the video to be recognized V, that is:

$$A = [ \begin{matrix}p 11 ⋆ x 11 & p 12 ⋆ x 12 \\ p 21 ⋆ x 21 & p 22 ⋆ x 22\end{matrix} ] .$$

For detailed descriptions of S602 to S603 shown in FIG. 7, refer to S602 to S603 shown in FIG. 6. For detailed descriptions of S501 shown in FIG. 7, refer to S501 shown in FIG. 5. For detailed descriptions of S301 shown in FIG. 7, refer to S301 shown in FIG. 3. For detailed descriptions of S201 to S202, and S204 shown in FIG. 7, refer to S201 to S202, and S204 shown in FIG. 2. Details are not described herein again.

In this embodiment of the present disclosure, the server performs weight adjustment processing by distinguishing importance of different feature parameters, so that more accurate first reference feature data of the video to be recognized can be obtained, thereby providing strong support for the subsequent obtaining of more accurate target feature data of the video to be recognized.

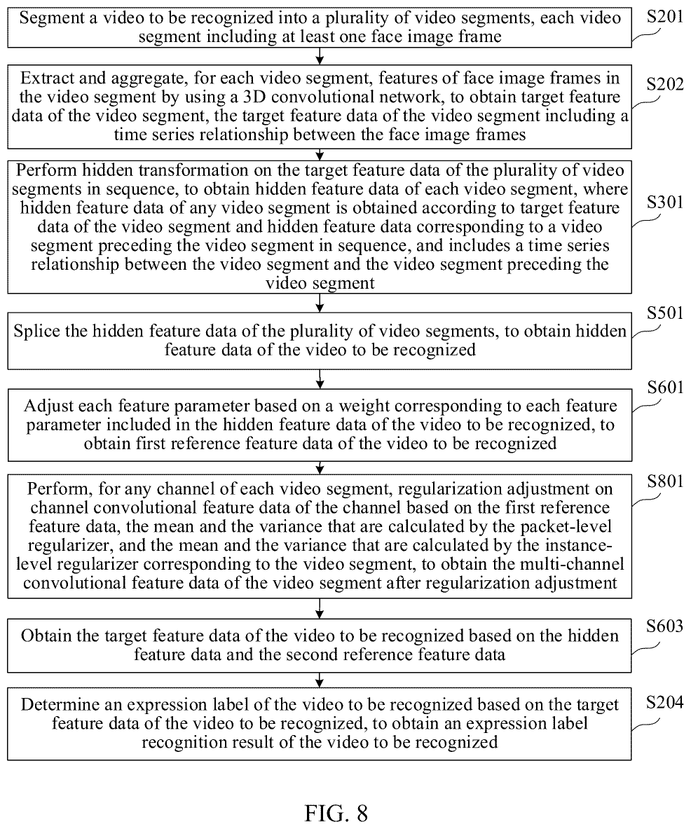

In some embodiments of the present disclosure, another dynamic facial expression recognition method is provided. The dynamic facial expression recognition method may be performed by the server 102. As shown in FIG. 8, the dynamic facial expression recognition method may include S801, S601, S603, S501, S301, S201 to S202, and S204.

In this embodiment of the present disclosure, the video to be recognized corresponds to a packet-level regularizer, where the packet-level regularizer is configured to calculate a mean and a variance of multi-channel convolutional feature data corresponding to the video segments included in the video to be recognized.

In this embodiment of the present disclosure, each video segment corresponds to an instance-level regularizer, where the instance-level regularizer is configured to calculate a mean and a variance of multi-channel convolutional feature data of video segments corresponding to the instance-level regularizer.

S801 is described in detail as follows.

S801: Perform, for any channel of each video segment, regularization adjustment on channel convolutional feature data of the channel based on the first reference feature data, the mean and the variance that are calculated by the packet-level regularizer, and the mean and the variance that are calculated by the instance-level regularizer corresponding to the video segment, to obtain the multi-channel convolutional feature data of the video segment after regularization adjustment.

In this embodiment of the present disclosure, for any channel of each video segment, the server performs regularization adjustment on the channel convolutional feature data of the channel based on the first reference feature data, the mean and the variance that are calculated by the packet-level regularizer, and the mean and the variance that are calculated by the instance-level regularizer corresponding to the video segment, to obtain the multi-channel convolutional feature data of the video segment after regularization adjustment.

For example, still using the foregoing example, the video segment I₁ is used as an example. It is assumed that the video segment I₁ corresponds to two channels, and the two channels are respectively c1 and c2. In this case, regularization adjustment is performed on channel convolutional feature data of the channel c1 based on the first reference feature data, the mean and the variance that are calculated by the packet-level regularizer, and the mean and the variance that are calculated by the instance-level regularizer corresponding to the video segment, to obtain convolutional feature data of the channel c1 after regularization adjustment on the video segment I₁. In addition, regularization adjustment is performed on channel convolutional feature data of the channel c2 based on the first reference feature data, the mean and the variance that are calculated by the packet-level regularizer, and the mean and the variance that are calculated by the instance-level regularizer corresponding to the video segment, to obtain convolutional feature data of the channel c2 after regularization adjustment on the video segment I₁. In this way, the convolutional feature data of the two channels c1 and c2 after regularization adjustment on the video segment I₁ is obtained. By analogy, adjusted multi-channel convolutional feature data respectively corresponding to the other video segments I₂-I₅ can be obtained. Details are not described herein again.

In some embodiments of the present disclosure, the process of performing regularization adjustment on channel convolutional feature data of the channel based on the first reference feature data, the mean and the variance that are calculated by the packet-level regularizer, and the mean and the variance that are calculated by the instance-level regularizer corresponding to the video segment in S801 may include:
obtaining a weight of the packet-level regularizer and a weight of the instance-level regularizer corresponding to the video segment; and
performing regularization adjustment on the channel convolutional feature data of the channel based on the first reference feature data, the weight of the packet-level regularizer, the mean and the variance that are calculated by the packet-level regularizer, the weight of the instance-level regularizer, and the mean and the variance that are calculated by the instance-level regularizer.

In an embodiment, a weight is set for the packet-level regularizer, and a weight is also set for the instance-level regularizer. In actual application, the weight of the packet-level regularizer and the weight of the instance-level regularizer corresponding to the video segment may be flexibly adjusted according to a specific application scenario. Weights of instance-level regularizers corresponding to different video segments may be the same or may be different.

That is, in an embodiment, the server performs regularization adjustment on the channel convolutional feature data of the channel based on the first reference feature data, the weight of the packet-level regularizer, the mean and the variance that are calculated by the packet-level regularizer, the weight of the instance-level regularizer, and the mean and the variance that are calculated by the instance-level regularizer.

For example, still using the foregoing example, regularization adjustment is performed on the channel convolutional feature data of the channel c1 based on the first reference feature data, the weight of the packet-level regularizer, the mean and the variance that are calculated by the packet-level regularizer, the weight of the instance-level regularizer, and the mean and the variance that are calculated by the instance-level regularizer, to obtain the convolutional feature data of the channel c1 after regularization adjustment on the video segment I₁. In addition, regularization adjustment is performed on the channel convolutional feature data of the channel c2 based on the first reference feature data, the weight of the packet-level regularizer, the mean and the variance that are calculated by the packet-level regularizer, the weight of the instance-level regularizer, and the mean and the variance that are calculated by the instance-level regularizer, to obtain the convolutional feature data of the channel c2 after regularization adjustment on the video segment I₁. In this way, the convolutional feature data of the two channels c1 and c2 after regularization adjustment on the video segment I₁ is obtained. By analogy, adjusted multi-channel convolutional feature data respectively corresponding to the other video segments I₂-I₅ can be obtained. Details are not described herein again.

For detailed descriptions of S601 and S603 shown in FIG. 8, refer to S601 and S603 shown in FIG. 6. For detailed descriptions of S501 shown in FIG. 8, refer to S501 shown in FIG. 5. For detailed descriptions of S301 shown in FIG. 8, refer to S301 shown in FIG. 3. For detailed descriptions of S201 to S202, and S204 shown in FIG. 8, refer to S201 to S202, and S204 shown in FIG. 2. Details are not described herein again.

In this embodiment of the present disclosure, the server performs weight adjustment processing by distinguishing importance of different regularizers, so that more accurate second reference feature data of the video to be recognized can be obtained, thereby providing strong support for subsequent obtaining of more accurate target feature data of the video to be recognized.

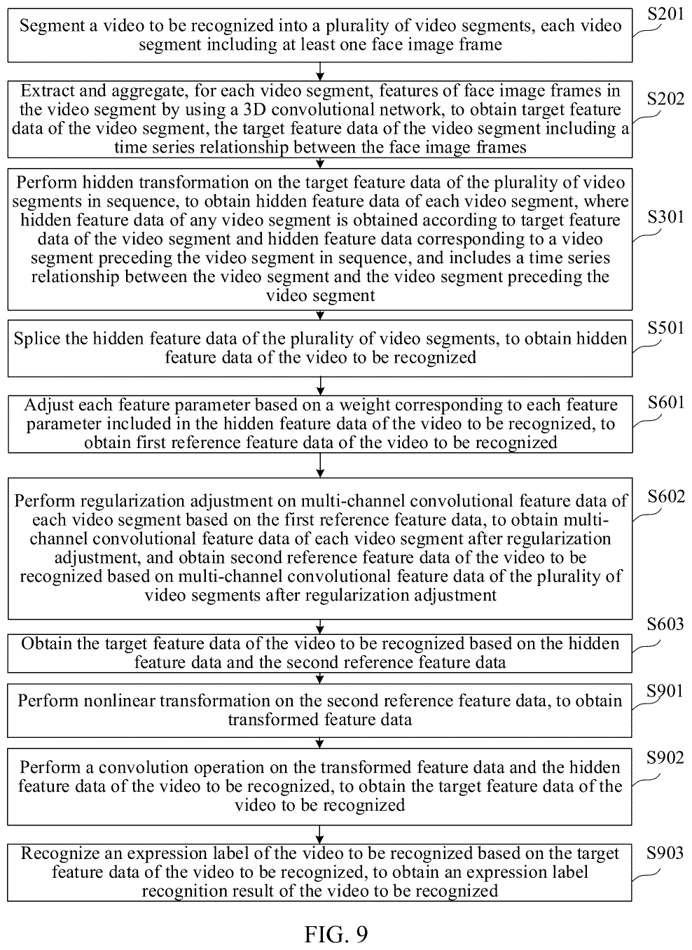

In some embodiments of the present disclosure, another dynamic facial expression recognition method is provided. The dynamic facial expression recognition method may be performed by the server 102. As shown in FIG. 9, the dynamic facial expression recognition method may include S901 to S903, S601 to S603, S501, S301, and S201 to S202.

S901 to S903 are described in detail as follows.

S901: Perform nonlinear transformation on the second reference feature data, to obtain transformed feature data.

In this embodiment of the present disclosure, the nonlinear transformation refers to performing reversal of the spatial dimension on the second reference feature data, to implement mapping from low-dimensional space to high-dimensional space, or to implement mapping from high-dimensional space to low-dimensional space. It is the opposite of linear transformation. The linear transformation may use matrix multiplication to represent transformation, but the nonlinear transformation cannot use matrix multiplication to represent transformation. The second reference feature data can be better explained through the nonlinear transformation.

In this embodiment of the present disclosure, the nonlinear transformation includes, but is not limited to, power function transformation, logarithmic function transformation, exponential function transformation, arc tangent function transformation, and the like. The exponential function transformation includes, but is not limited to, a Sigmoid function (also referred to as an S-type function).

In this embodiment of the present disclosure, after performing regularization adjustment on the multi-channel convolutional feature data of each video segment, to obtain the multi-channel convolutional feature data of each video segment after regularization adjustment, and obtaining the second reference feature data of the video to be recognized based on the multi-channel convolutional feature data of the plurality of video segments after regularization adjustment, the server may perform nonlinear transformation on the second reference feature data, to obtain the transformed feature data.

In some embodiments of the present disclosure, the process of performing nonlinear transformation on the second reference feature data, to obtain transformed feature data in S901 may include:

performing nonlinear transformation on the second reference feature data through a Sigmoid function, to obtain the transformed feature data.

For example, if the second reference feature data is represented by Â, nonlinear transformation is performed on the second reference feature data through the Sigmoid function, to obtain transformed feature data Sigmoid(Â).

S902: Perform a convolution operation on the transformed feature data and the hidden feature data of the video to be recognized, to obtain the target feature data of the video to be recognized.

In this embodiment of the present disclosure, after performing nonlinear transformation on the second reference feature data, to obtain the transformed feature data, the server may perform the convolution operation on the transformed feature data and the hidden feature data, to obtain the target feature data of the video to be recognized.

In this embodiment of the present disclosure, the convolution operation means that tensor transformation feature data and the hidden feature data are inputted, a convolution kernel is applied to all points of the tensor transformation feature data and the hidden feature data, and a filtering tensor operation is generated by sliding the convolution kernel on the tensor transformation feature data and the hidden feature data, thereby extracting/matching features of the transformed feature data and the hidden feature data.

In some embodiments of the present disclosure, the process of performing a convolution operation on the transformed feature data and the hidden feature data of the video to be recognized, to obtain the target feature data of the video to be recognized in S902 may include:
inputting the transformed feature data and the hidden feature data into a one-dimensional convolutional layer; and
performing the convolution operation on the transformed feature data and the hidden feature data through the one-dimensional convolutional layer, to obtain the target feature data of the video to be recognized.

For example, still using the foregoing example, if the hidden feature data of the video to be recognized is represented by X, and the one-dimensional convolution layer is represented by Conv1D, the convolution operation is performed on the transformed feature data Sigmoid(Â) and the hidden feature data X through the one-dimensional convolution layer Conv1D, to obtain the target feature data Z of the video to be recognized V, that is, Z=Conv1D (X×Sigmoid(Â)).

S903: Recognize an expression label of the video to be recognized based on the target feature data of the video to be recognized, to obtain an expression label recognition result of the video to be recognized.

In this embodiment of the present disclosure, after performing the convolution operation on the transformed feature data and the hidden feature data, to obtain the target feature data of the video to be recognized, the server may recognize the expression label of the video to be recognized based on the target feature data of the video to be recognized, to obtain the expression label recognition result of the video to be recognized.

For example, still using the foregoing example, the target feature data Z of the video to be recognized Vis inputted into a fully convolutional layer, and an expression label of the video to be recognized Vis recognized through the fully convolutional layer, to obtain an expression label recognition result of the video to be recognized V.

For detailed descriptions of S601 to S603 shown in FIG. 9, refer to S601 to S603 shown in FIG. 6. For detailed descriptions of S501 shown in FIG. 9, refer to S501 shown in FIG. 5. For detailed descriptions of S301 shown in FIG. 9, refer to S301 shown in FIG. 3. For detailed descriptions of S201 to S202 shown in FIG. 9, refer to S201 to S202 shown in FIG. 2. Details are not described herein again.

In this embodiment of the present disclosure, the server performs nonlinear transformation on the second reference feature data, to obtain the transformed feature data, and then performs the convolution operation on the transformed feature data and the hidden feature data, to obtain more accurate target feature data of the video to be recognized, leading to more accurate recognition on the expression label of the video to be recognized based on the target feature data of the video to be recognized, that is, further improving the accuracy of facial expression recognition.

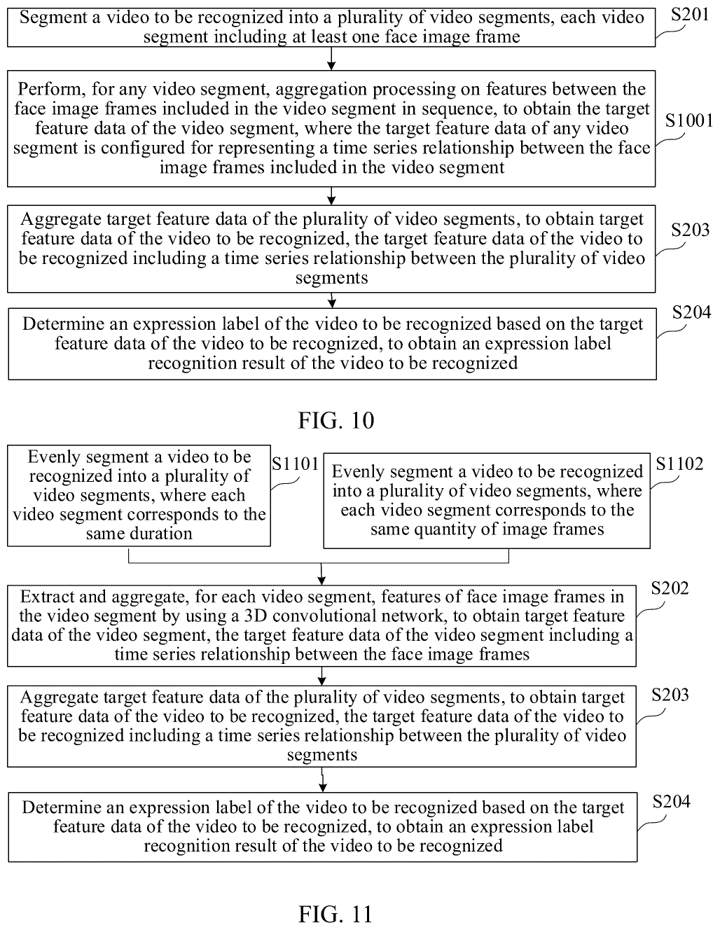

In some embodiments of the present disclosure, another dynamic facial expression recognition method is provided. The dynamic facial expression recognition method may be performed by the server 102. As shown in FIG. 10, the dynamic facial expression recognition method may include S1001, S201, and S203 to S204.

S1001 is described in detail as follows.

S1001: Perform, for any video segment, aggregation processing on features between the face image frames included in the video segment in sequence, to obtain the target feature data of the video segment.

The target feature data of any video segment is configured for representing a time series relationship between the face image frames included in the video segment.

In this embodiment of the present disclosure, the sequence refers to a chronological sequence of the plurality of face image frames. Correspondingly, the time series relationship refers to a chronological relationship of the plurality of face image frames.

For example, still using the foregoing example, the video segment I₁ is used as an example. The video segment I₁ corresponds to 09:00:00-09:00:05. In addition, it is assumed that the video segment I₁ includes 300 face image frames. The first to 60^{th} face image frames correspond to 09:00:00-09:00:01, the 61^{st} to 120^{th} face image frames correspond to 09:00:01-09:00:02, the 121^{st} to 180^{th} face image frames correspond to 09:00:02-09:00:03, the 181^{st} to 240^{th} face image frames correspond to 09:00:03-09:00:04, and the 241^{st} to 300^{th} face image frames correspond to 09:00:04-09:00:05. A sequence or time series relationship between the 300 face image frames is that the first to the 60^{th} face image frames are the face image frames of the first 1 second, the 61^{st} to the 120^{th} face image frames are the adjacent face image frames 1 second after the 60^{th} face image frame, the 121^{st} to the 180^{th} face image frames are the adjacent face image frames 1 second after the 120^{th} face image frame, the 181^{st} to the 240^{th} face image frames are the adjacent face image frames 1 second after the 180^{th} face image frame, and the 241^{st} to 300^{th} face image frames are the adjacent face image frames 1 second after the 240^{th} face image frame. A sequence and a time series relationship between face image frames respectively corresponding to the other video segments I₂-I₅ can be deduced by analogy. Details are not described herein again.

In this embodiment of the present disclosure, any video segment refers to each of the plurality of video segments.

For example, still using the foregoing example, the video segment I₁, the video segment I₂, the video segment I₃, the video segment I₄, and the video segment I₅ are any video segment.

In some embodiments of the present disclosure, the process of performing aggregation processing on features between the face image frames included in the video segment in sequence, to obtain the target feature data of the video segment in S1001 may include:
extracting three-dimensional feature data of the face image frames included in any video segment in sequence; and
splicing the extracted three-dimensional feature data, to obtain the target feature data of any video segment in sequence.

In an embodiment, the server extracts the three-dimensional feature data of the face image frames included in any video segment in sequence, and splices the extracted three-dimensional feature data in sequence, to obtain the target feature data of any video segment.

For example, still using the foregoing example, assuming that the video segment I₁ is any video segment, three-dimensional feature data f1-f60 of the first to the 60^{th} face image frames are extracted, then three-dimensional feature data f60-f120 of the 61^{st} to the 120^{th} face image frames are extracted, then three-dimensional feature data f121-f180 of the 121^{st} to the 180^{th} face image frames are extracted, then three-dimensional feature data f181-f240 of the 181^{st} to the 240^{th} face image frames are extracted, and then three-dimensional feature data f241-f300 of the 241^{st} to 300^{th} face image frames are extracted. Then, splicing is performed according to an sequence of f1-f60, f60-f120, f121-f180, f181-f240, and f241-f300, that is, (f1-f60)+(f61-f120)+(f121-f180)+(f181-f240)+(f241-f300), to obtain the target feature data of the video segment I₁.

Similarly, the process of obtaining target feature data respectively corresponding to the other video segments I₂-I₅ can be deduced by analogy. Details are not described herein again.

By implementing the embodiment, the three-dimensional feature data of the face image frames included in the video segment is extracted in sequence. Since the three-dimensional feature data includes a large amount of information, more accurate target feature data of the video segment can be obtained.

In other embodiments, the server may extract two-dimensional feature data of the face image frames included in any video segment in sequence, and then splice the extracted two-dimensional feature data in sequence, to obtain the target feature data of any video segment. In actual application, a dimension of the extracted feature data may be flexibly adjusted according to a specific application scenario.

By implementing the embodiment, the two-dimensional feature data of the face image frames included in the video segment is spliced in sequence. Since the two-dimensional feature data includes a small amount of information, the extraction efficiency is higher, and the target feature data of the video segment can be quickly obtained.

For detailed descriptions of S201, and S203 to S204 shown in FIG. 10, refer to S201, and S203 to S204 shown in FIG. 2. Details are not described herein again.

In this embodiment of the present disclosure, the server performs aggregation processing on the features between the face image frames included in the video segment, to capture an association between the face image frames in the video segment. In this way, the obtained target feature data of the video segment is more accurate, so that the recognition on the expression label of the video to be recognized is more accurate based on the more accurate target feature data of the video to be recognized, thereby improving the accuracy of facial expression recognition.

In some embodiments of the present disclosure, another dynamic facial expression recognition method is provided. The dynamic facial expression recognition method may be performed by the server 102. As shown in FIG. 11, the dynamic facial expression recognition method may include S1101 to S1102, and S202 to S204.

S1101 to S1102 are described in detail as follows.

S1101: Evenly segment a video to be recognized into a plurality of video segments, where each video segment corresponds to the same duration; or

S1102: Evenly segment a video to be recognized into a plurality of video segments, where each video segment corresponds to the same quantity of image frames.

In this embodiment of the present disclosure, the segmenting a video to be recognized, to obtain a plurality of video segments may include the following manners.

Manner 1: Evenly segment a video to be recognized into a plurality of video segments, where each video segment corresponds to the same duration.

For example, the video to be recognized is evenly segmented into five video segments I₁-I₅, where the video segments I₁-I₅ respectively correspond to duration of five seconds. In actual application, the duration corresponding to each video segment may be flexibly adjusted according to a specific application scenario.

Manner 2: Evenly segment a video to be recognized into a plurality of video segments, where each video segment corresponds to the same quantity of image frames.

For example, the video to be recognized is evenly segmented into five video segments I₁-I₅, where a quantity of image frames respectively corresponding to the video segments I₁-I₅ is 300. In actual application, the quantity of image frames corresponding to each video segment may be flexibly adjusted according to a specific application scenario.

For detailed descriptions of S202 to S204 shown in FIG. 11, refer to S202 to S204 shown in FIG. 2. Details are not described herein again.

In this embodiment of the present disclosure, the server evenly segments the video to be recognized into the plurality of video segments, to provide strong support for subsequent aggregation processing on the features between the face image frames included in the video segment. In addition, the process is simple, easy to implement, and applicable to a wide range of application scenarios.

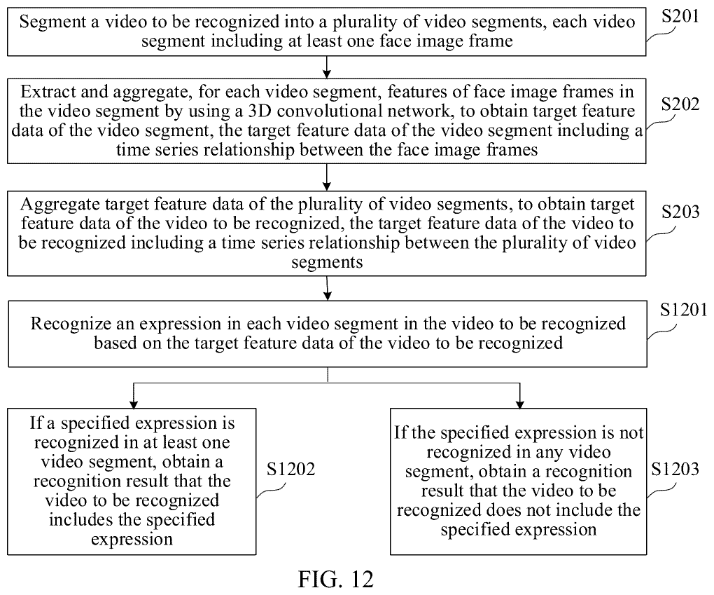

In some embodiments of the present disclosure, another dynamic facial expression recognition method is provided. The dynamic facial expression recognition method may be performed by the server 102. As shown in FIG. 12, the dynamic facial expression recognition method may include S1201 to S1203, and S201 to S203.

S1201 to S1203 are described in detail as follows.

S1201: Recognize an expression in each video segment in the video to be recognized based on the target feature data of the video to be recognized.

S1202: If a specified expression is recognized in at least one video segment, a recognition result is that the video to be recognized includes the specified expression.

S1203: If the specified expression is not recognized in any video segments, obtain a recognition result that the video to be recognized does not include the specified expression.

In this embodiment of the present disclosure, the server may recognize the expression in each video segment in the video to be recognized based on the target feature data of the video to be recognized by using a multi-instance learning mechanism. The multi-instance learning refers to a method that evolves from a supervised learning algorithm, and a “packet” is defined as a set of a plurality of instances. If at least one instance in the packet is positive, the packet may be labeled as positive and if all instances in the packet are negative, the packet may be labeled as negative. For example, the video to be recognized in this embodiment of the present disclosure may be considered as a packet, and each video segment in the video to be recognized may be considered as an instance.

In this embodiment of the present disclosure, the recognizing the expression in each video segment in the video to be recognized based on the target feature data of the video to be recognized by using a multi-instance learning mechanism may include the following cases.

Case 1: If a specified expression is recognized in at least one video segment, a recognition result that the video to be recognized includes the specified expression is obtained.

For example, still using the foregoing example, assuming that the specified expression is a joy expression, only when the joy expression is recognized in at least one of the video segments I₁-I₅ based on the target feature data of the video to be recognized, a recognition result that the video to be recognized includes the joy expression is obtained. In this case, the video to be recognized is a positive packet.

Case 2: If the specified expression is not recognized in any video segment, a recognition result that the video to be recognized does not include the specified expression is obtained.

For example, still using the foregoing example, assuming that the specified expression is a joy expression, only when the pleasant expression is not recognized in any of the video segments I₁-I₅ based on the target feature data of the video to be recognized, a recognition result that the video to be recognized does not include the specified expression is obtained. In this case, the video to be recognized is a negative packet.

For detailed descriptions of S201 to S203 shown in FIG. 12, refer to S201 to S203 shown in FIG. 2. Details are not described herein again.

In this embodiment of the present disclosure, the server can more accurately recognize the expression label of the video to be recognized based on the target feature data of the video to be recognized by using the multi-instance learning mechanism, to obtain the expression label recognition result of the video to be recognized, thereby improving the accuracy of facial expression recognition.

A specific scenario of this embodiment of the present disclosure is described in detail below.

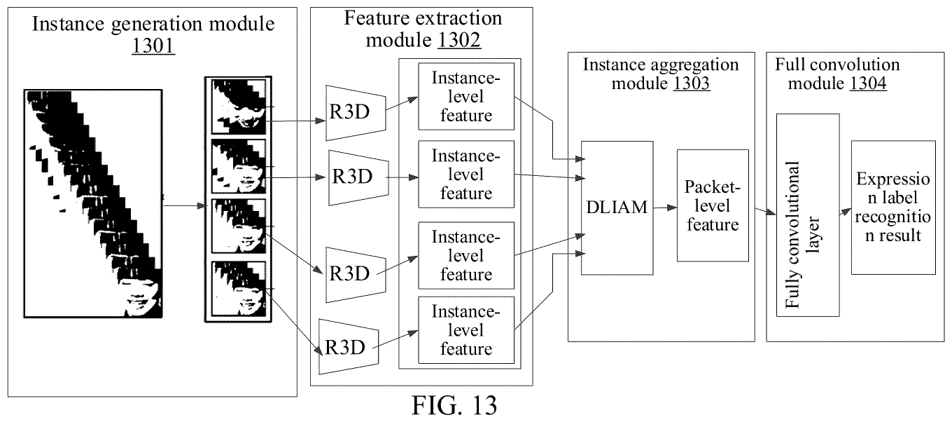

Referring to FIG. 13, an instance generation module 1301, a feature extraction module 1302, an instance aggregation module 1303, and a full convolution module 1304 are mainly included.

The instance generation module 1301 is mainly configured to segment a video to be recognized, to obtain a plurality of instances (that is, the video segments in the foregoing embodiments).

For example, the video to be recognized is represented by V, and the video to be recognized V includes T image frames and may be segmented into N instances, where all instances I=[I₁, I₂, . . . , and I_{N}], where Iₙ∈R^{3*T*H*w}, Iₙ is any one of [I₁, I₂, . . . , and I_{N}], 3 is three colors: red, green, and blue, T is a quantity of image frames (that is, the T image frames), His a height of an image frame, and W is a width of an image frame.

The feature extraction module 1302 is mainly configured to extract and aggregate features of face image frames included in each instance, to obtain an instance-level feature of each instance (that is, the target feature data of each video segment in the foregoing embodiments).

For example, for each instance, feature extraction and aggregation are performed on face image frames included in the instance by using a 3D residual convolutional neural network (R3D). During aggregation, three-dimensional feature data of the face image frames included in the instance is obtained based on a time series relationship between the face image frames included in the instance.

For example, still using the foregoing example, three-dimensional feature data Fₙ of the instance Iₙ is extracted through R3D, that is:

Fₙ=R3D(Iₙ)

where Fₙ is the three-dimensional feature data of the instance Iₙ.

Three-dimensional feature data Fₙ of a plurality of instances Iₙ forms three-dimensional feature data F of the video to be recognized V, where F∈R^{N×C}, N is a quantity of instances (that is, N instances), and C is a quantity of channels of an output feature.

In this way, strong modeling is performed on a short-term time series relationship in a dynamic expression, so that a single image frame that looks abnormal can be recognized as a part of a facial movement, and an unchanged expression/emotion is recognized when the facial movement exists, for example, an object speaks, thereby avoiding interference of the facial movement to facial expression recognition, and improving the accuracy of facial expression recognition.

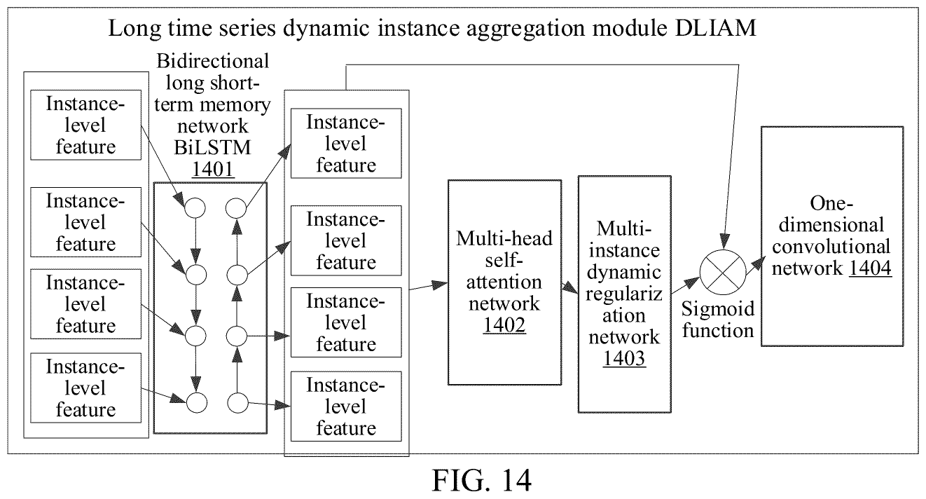

The instance aggregation module 1303 is mainly configured to aggregate instance-level features of a plurality of instances, to obtain packet-level feature data of the video to be recognized (that is, the target feature data of the video to be recognized in the foregoing embodiments). DLIAM shown in FIG. 14 refers to a long time series dynamic instance aggregation module.

For example, FIG. 14 is a schematic diagram of a long time series dynamic instance aggregation module. The long time series dynamic instance aggregation module mainly includes a bi-directional long short-term memory (BiLSTM) network 1401, a multi-head self-attention (MHSA) network 1402, a multi-instance dynamic regularization network 1403, and a one-dimensional convolutional network 1404.

The BiLSTM 1401 is formed by combining a forward LSTM and a backward LSTM, and is mainly configured to perform iterative hidden transformation on instance-level features of each instance, to obtain hidden feature data of each instance.

For example, still using the foregoing example, hidden feature data Xₙ of the instance Iₙ is obtained through BiLSTM, that is:

$${X}_{n} , {H}_{n} = BiLSTM ( {F}_{n} , {H}_{n - 1} )$$

where Hₙ is an n^{th} hidden state of BiLSTM, Hₙ₋₁ is an (n−1)^{th} hidden state of BiLSTM, Xₙ is the hidden feature data of the instance Iₙ, and Xₙ₋₁ is hidden feature data of an instance Iₙ₋₁.

Hidden feature data Xₙ of a plurality of instances IL forms the hidden feature data X of the video to be recognized V.

The multi-head self-attention network 1402 is mainly configured to perform weight adjustment on each feature parameter included in the hidden feature data of the video to be recognized, to obtain a first reference feature matrix of the video to be recognized.

For example, still using the foregoing example, the multi-head self-attention network performs weight adjustment on each feature parameter included in the hidden feature data X of the video to be recognized V, to obtain a first reference feature matrix A of the video to be recognized V, that is:

A=MHSA(X)

where A is the first reference feature matrix of the video to be recognized V, and A∈R^{N×C}.

The multi-instance dynamic regularization network 1403 is mainly configured to perform regularization adjustment on the multi-channel convolutional feature data of each instance based on the first reference feature matrix, to obtain multi-channel convolutional feature data after regularization adjustment on each instance, and obtain a second reference feature matrix of the video to be recognized based on the multi-channel convolutional feature data after regularization adjustment on a plurality of instances.

For example, still using the foregoing example, regularization adjustment is performed on convolutional feature data of a c^{th} channel of the instance Iₙ based on the first reference feature matrix A, to obtain convolutional feature data Â_{nc} of the c^{th} channel after regularization adjustment on the instance Iₙ, that is:

$${\hat{A}}_{n c} = \frac{{A}_{n c} - {\sum }_{k ∈ K} {w}_{k} {μ}_{k}}{\sqrt{{\sum }_{k ∈ K} {w}_{k}^{′} {σ}_{k}^{2}} + ϵ} * γ + β$$

where Â_{nc} is the convolutional feature data of the c^{th} channel after regularization adjustment on the instance Iₙ; and A_{nc} is the convolutional feature data of the c^{th} channel before regularization adjustment on the instance Iₙ.

k is a regularizer, K=bn, in, bn is a packet-level regularizer, and in is an instance-level regularizer; μₖ is a mean of channel values of the instance calculated by the regularizer k, and σₖ is a variance of the channel values of the instance calculated by the regularizer k; and wₖ and wₖ′ are weights of the regularizer k.

ϵ is an extremely decimal number to ensure mathematical stability; and γ and β are learnable transform parameters.

For example,

$${μ}_{b n} = \frac{1}{N C} {\sum }_{n , c}^{N , C} {A}_{nc} , {σ}_{b n} = \frac{1}{N C} {\sum }_{n , c}^{N , C} {( {A}_{n c} - {μ}_{b n} )}^{2}$$

where μᵢₙ,σᵢₙ∈R¹.

For example,

$${μ}_{i n} = \frac{1}{N} {\sum }_{n}^{N} {A}_{nc} , {σ}_{i n} = \frac{1}{N} {\sum }_{n}^{N} {( {A}_{n c} - {μ}_{i n} )}^{2}$$

where μᵢₙ, σᵢₙ∈R¹.

For example,

$${\sum }_{k ∈ K} {w}_{k} = 1 , {\sum }_{k ∈ K} {w}_{k}^{′} = 1$$

$${w}_{k} = \frac{{e}^{{λ}_{k}}}{{\sum }_{j ∈ 𝒦} {e}^{{λ}_{j}}}$$

where λ is a learnable parameter.

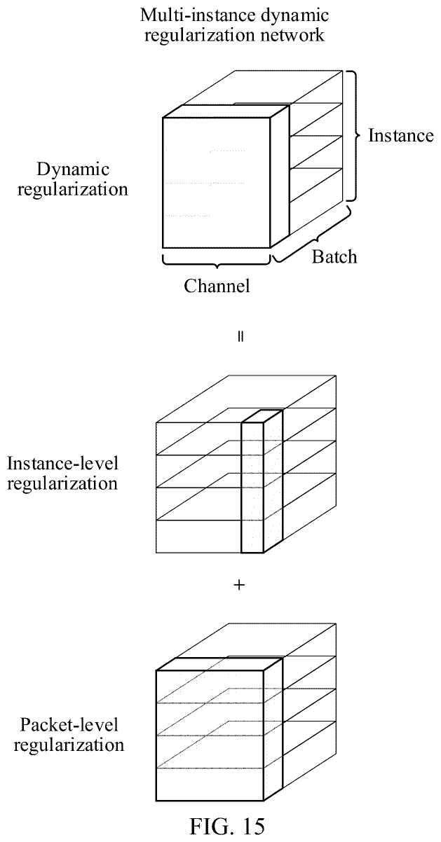

For example, FIG. 15 is a schematic diagram of an exemplary multi-instance dynamic regularization network. As shown in FIG. 15, regularization processing is performed through both the packet-level regularizer and the instance-level regularizer, to obtain a final regularization processing result. In FIG. 15, channel represents a channel, batch represents a batch (that is, a data volume used in one iteration), and instances represents instances. In actual application, regularization processing may be flexibly adjusted according to a specific application scenario. For example, regularization processing may be packet-level regularization processing through the packet-level regularizer only or instance-level regularization processing through the instance-level regularizer only.

The multi-channel convolutional feature data Â_{nc} obtained after regularization adjustment on the plurality of instances Iₙ forms the second reference feature matrix Â of the video to be recognized V.

The one-dimensional convolutional network 1404 is mainly configured to perform nonlinear transformation on the second reference feature matrix, to obtain transformed feature data, and perform a convolution operation on the transformed feature data and a hidden feature matrix, to obtain target feature data of the video to be recognized.

For example, still using the foregoing example, a one-dimensional convolutional network Conv1D uses the Sigmoid algorithm, and performs nonlinear transformation on the second reference feature matrix A by using the Sigmoid algorithm, to obtain the transformed feature data, that is:

Sigmoid(Â)

Further, the convolution operation is performed on transformed feature data Sigmoid(Â) and hidden feature matrix X, to obtain target feature data Z of the video to be recognized V, that is:

$$Z = Conv 1 D ( X \times Sigmoid ( \hat{A} ) )$$

In this way, strong modeling is performed on a long-term time series relationship in a dynamic expression, to establish an association between instances, thereby further avoiding interference to facial expression recognition and improving the accuracy of facial expression recognition.

The full convolution module 1304 is mainly configured to determine an expression label of the video to be recognized based on the packet-level feature data of the video to be recognized, to obtain an expression label recognition result of the video to be recognized.

For example, still using the foregoing example, the target feature data Z of the video to be recognized Vis inputted into a fully convolutional layer, and an expression label of the video to be recognized Vis recognized through the fully convolutional layer, to obtain an expression label recognition result of the video to be recognized V.

The specific formulas shown in FIG. 13 to FIG. 15 may be flexibly adjusted according to a specific application scenario, for example, a corresponding parameter is increased or decreased. In addition, refer to the foregoing embodiment for detailed descriptions of FIG. 13 to FIG. 15. Details are not described herein again.

In this embodiment of the present disclosure, the server establishes a short-term time series association between the face image frames and a long-term time series association between the video segments by starting from both the fine granularity dimension of the face image frame and the coarse granularity dimension of the video segment, thereby reducing the negative impact of weak supervision on facial expression recognition, and improving the accuracy of facial expression recognition.

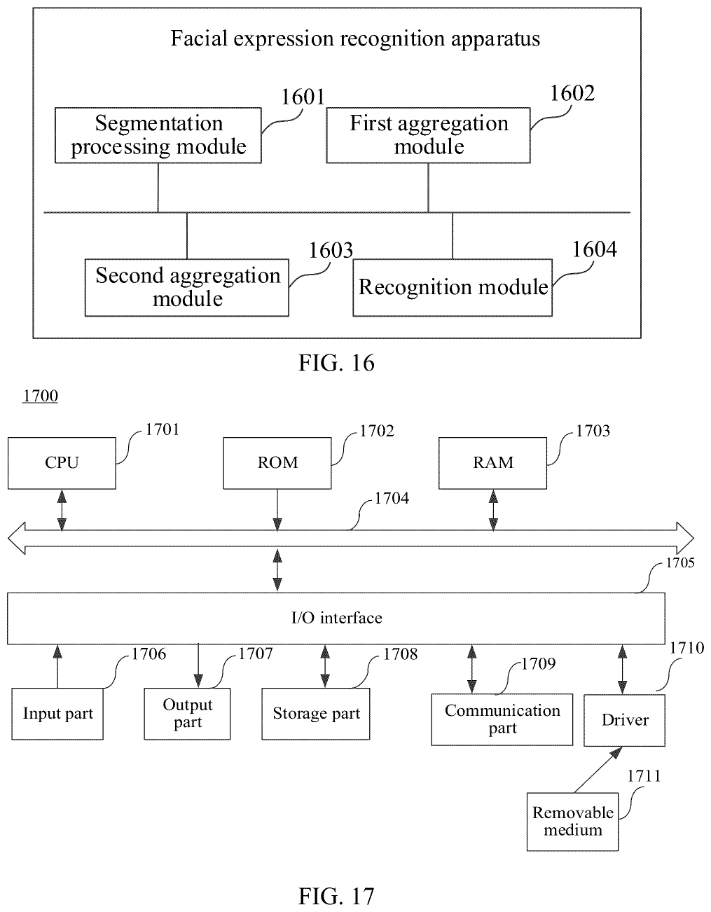

FIG. 16 is a block diagram of a dynamic facial expression recognition apparatus according to some embodiments of the present disclosure. As shown in FIG. 16, the dynamic facial expression recognition apparatus includes:
a segmentation processing module 1601, configured to segment a video to be recognized into a plurality of video segments, each video segment including at least one face image frame;
a first aggregation module 1602, configured to: extract and aggregate, for each video segment, features of face image frames in the video segment by using a 3D convolutional network, to obtain target feature data of the video segment, the target feature data of the video segment including a time series relationship between the face image frames;
a second aggregation module 1603, configured to aggregate target feature data of the plurality of video segments, to obtain target feature data of the video to be recognized, the target feature data of the video to be recognized including a time series relationship between the plurality of video segments; and
a recognition module 1604, configured to determine an expression label of the video to be recognized based on the target feature data of the video to be recognized, to obtain an expression label recognition result of the video to be recognized.

The apparatus provided in the foregoing embodiments and the method provided in the foregoing embodiments belong to the same idea, and specific manners of performing operations by the modules and units have been described in detail in the method embodiments.

An embodiment of the present disclosure further provides an electronic device. The electronic device includes: one or more processors; and a memory, configured to store one or more programs, the one or more programs, when executed by the one or more processors, causing the electronic device to implement the foregoing dynamic facial expression recognition method.

FIG. 17 is a schematic structural diagram of a computer system of an electronic device suitable for implementing the embodiments of the present disclosure. A computer system 1700 of the electronic device shown in FIG. 17 is merely an example, and is not to bring any limitation to the function and use range of the embodiments of the present disclosure.

As shown in FIG. 17, the computer system 1700 includes a central processing unit (CPU) 1701, which may perform various suitable actions and processing according to a program stored in a read-only memory (ROM) 1702 or a program loaded from a storage portion 1708 to a random access memory (RAM) 1703, for example, perform the methods in the foregoing embodiments. The RAM 1703 further has various programs and data required by system operations stored therein. The CPU 1701, the ROM 1702, and the RAM 1703 are connected to each other by using a bus 1704. An input/output (I/O) interface 1705 is also connected to the bus 1704.

The following components are connected to the I/O interface 1705: an input portion 1706 including a keyboard, a mouse, and the like; an output portion 1707 including a cathode ray tube (CRT), a liquid crystal display (LCD), a speaker, and the like; a storage portion 1708 including a hard disk, and the like; and a communication portion 1709 of a network interface card including a local area network (LAN) card, a modem, and the like. The communication portion 1709 performs communication processing by using a network such as the Internet. A driver 1710 is also connected to the I/O interface 1705 according to requirements. A removable medium 1711, such as a magnetic disk, an optical disc, a magneto-optical disk, or a semiconductor memory, is installed on the driver 1710 according to requirements, so that a computer program read from the removable medium 1711 is installed into the storage portion 1708 according to requirements.

Particularly, according to an embodiment of the present disclosure, the processes described in the foregoing by referring to the flowcharts may be implemented as computer software programs. For example, an embodiment of the present disclosure includes a computer program product, including a computer program carried in a computer readable medium. The computer program includes a computer program configured for performing the methods shown in the flowcharts. In such an embodiment, the computer program may be downloaded and installed from a network and/or installed from the removable medium 1711 through the communication portion 1709. When the computer program is executed by the central processing unit (CPU) 1701, various functions defined in the system of the present disclosure are performed.

The computer-readable medium shown in the embodiments of the present disclosure may be a computer-readable signal medium, a computer-readable storage medium, or any combination thereof. The computer-readable medium may be, for example, an electronic, magnetic, optical, electromagnetic, infrared, or semiconductor system, apparatus, or device, or a combination of any of the foregoing. More specific examples of the computer-readable medium may include but are not limited to: an electrical connection having one or more wires, a portable computer diskette, a hard disk, a random access memory (RAM), a read-only memory (ROM), an erasable programmable read only memory (EPROM), a flash memory, an optical fiber, a portable compact disc read-only memory (CD-ROM), an optical storage device, a magnetic storage device, or any suitable combination thereof. In the present disclosure, the computer-readable medium may be any tangible medium that includes or stores a program, and the program may be used by an instruction execution system, apparatus, or device or may be used in combination with the instruction execution system, apparatus, or device. In the present disclosure, the computer-readable signal medium may include a data signal propagated in a baseband or as a part of a carrier, and carries a computer-readable computer program. The propagated data signal may be in a plurality of forms, including, but not limited to, an electromagnetic signal, an optical signal, or any appropriate combination thereof. The computer-readable signal medium may be further any computer-readable medium in addition to a computer-readable storage medium. The computer-readable medium may send, propagate, or transmit a program that is used by or used in combination with an instruction execution system, apparatus, or device. The computer program included in the computer-readable medium may be transmitted by using any suitable medium, including but not limited to: a wireless medium, a wire medium, and the like, or any suitable combination thereof.

The flowcharts and block diagrams in the accompanying drawings illustrate possible system architectures, functions, and operations that may be implemented by a system, a method, and a computer program product according to various embodiments of the present disclosure. Each box in a flowchart or a block diagram may represent a module, a program segment, or a part of code. The module, the program segment, or the part of code includes one or more executable instructions configured for implementing designated logic functions. In some implementations used as substitutes, functions annotated in blocks may occur in a sequence different from that annotated in an accompanying drawing. For example, actually two blocks shown in succession may be performed basically in parallel, and sometimes the two blocks may be performed in a reverse sequence. This is determined by a related function. Each block in the block diagram or the flowchart, and a combination of blocks in the block diagram or the flowchart may be implemented by using a dedicated hardware-based system that performs a specified function or operation, or may be implemented by using a combination of dedicated hardware and computer instructions.

Related units described in the embodiments of the present disclosure may be implemented in a software manner, or may be implemented in a hardware manner, and the unit described can also be set in a processor. Names of these units do not constitute a limitation on the units in a case.

Another aspect of the present disclosure further provides a computer-readable medium. The computer-readable medium has a computer program stored therein, the computer program, when executed by a processor, causing the foregoing dynamic facial expression recognition method to be implemented. The computer-readable medium may be included in the electronic device described in the foregoing embodiment, or may exist alone and is not assembled into the electronic device.

Another aspect of the present disclosure further provides a computer program product or a computer program. The computer program product or the computer program includes computer-executable instructions. The computer-executable instructions are stored in a computer-readable storage medium. A processor of the computer device reads the computer instructions from the computer-readable medium. The processor executes the computer instructions, so that the computer device performs the dynamic facial expression recognition method provided in the foregoing embodiments.

The foregoing descriptions are merely preferred exemplary embodiments of the present disclosure, and are not intended to limit implementations of the present disclosure. A person of ordinary skill in the art can make corresponding variations or modifications conveniently according to the main idea of the present disclosure. Therefore, the protection scope of the present disclosure is subject to the protection scope required by the claims.

What is claimed is:

1. A dynamic facial expression recognition method, performed by a computer device, the method comprising:
segmenting a video to be recognized into a plurality of video segments, each video segment comprising at least one face image frame;
extracting and aggregating, for each video segment, features of face image frames in the video segment with a 3D convolutional network to obtain target feature data of the video segment, the target feature data of the video segment including a time series relationship between the face image frames;
aggregating target feature data of the plurality of video segments, to obtain target feature data of the video to be recognized, the target feature data of the video to be recognized including a time series relationship between the plurality of video segments; and
determining an expression label of the video to be recognized based on the target feature data of the video to be recognized, to obtain an expression label recognition result of the video to be recognized.

2. The method according to claim 1, wherein aggregating the target feature data of the plurality of video segments, to obtain the target feature data of the video to be recognized comprises:
performing hidden feature analysis on the target feature data of the plurality of video segments in sequence, to obtain hidden feature data of each video segment, wherein
hidden feature data of one of the video segments is obtained according to target feature data of the video segment and hidden feature data corresponding to a video segment preceding the video segment in sequence, and is configured according to a time series relationship between the video segment and the video segment preceding the video segment; and
aggregating hidden feature data of the plurality of video segments, to obtain the target feature data of the video to be recognized.

3. The method according to claim 2, wherein performing the hidden feature analysis on the target feature data of the plurality of video segments in sequence, to obtain the hidden feature data of each video segment comprises:
sequentially inputting the target feature data of the plurality of video segments into a recurrent neural network in sequence; and
for one of the video segments, performing iterative hidden feature analysis on target feature data of the video segment by using the recurrent neural network and based on hidden feature data corresponding to a video segment preceding the video segment in sequence, to obtain hidden feature data of the video segment.

4. The method according to claim 2, wherein aggregating the hidden feature data of the plurality of video segments, to obtain the target feature data of the video to be recognized comprises:
splicing the hidden feature data of the plurality of video segments, to obtain hidden feature data of the video to be recognized; and
performing weight adjustment on the hidden feature data of the video to be recognized based on a preset weight adjustment mechanism, to obtain the target feature data of the video to be recognized.

5. The method according to claim 4, wherein performing the weight adjustment on the hidden feature data of the video to be recognized based on the preset weight adjustment mechanism, to obtain the target feature data of the video to be recognized comprises:
adjusting each feature parameter comprised in the hidden feature data of the video to be recognized based on a weight corresponding to each feature parameter with a multi-head self-attention network, to obtain first reference feature data of the video to be recognized;
performing regularization adjustments on multi-channel convolutional feature data of each video segment based on the first reference feature data with a multi-instance dynamic regularization network, to obtain multi-channel convolutional feature data of each video segment after regularization adjustments, and to obtain second reference feature data of the video to be recognized based on multi-channel convolutional feature data of the plurality of video segments after regularization adjustment; and
obtaining the target feature data of the video to be recognized based on the hidden feature data and the second reference feature data of the video to be recognized by using a one-dimensional convolutional network.

6. The method according to claim 5, wherein adjusting each feature parameter comprised in the hidden feature data of the video to be recognized based on the weight corresponding to each feature parameter, to obtain first reference feature data of the video to be recognized comprises:
assigning a weight to each feature parameter comprised in the hidden feature data of the video to be recognized;
performing a multiplication operation on each feature parameter and the weight corresponding to each feature parameter, to obtain an operation result corresponding to each feature parameter; and
replacing each feature parameter with the operation result corresponding to each feature parameter, to obtain the first reference feature data of the video to be recognized.

7. The method according to claim 5, wherein the multi-instance dynamic regularization network comprises a packet-level regularizer corresponding to the video to be recognized and an instance-level regularizer corresponding to each video segment, wherein the packet-level regularizer is configured to calculate a mean and a variance of multi-channel convolutional feature data corresponding to the video segments comprised in the video to be recognized, and the instance-level regularizer is configured to calculate a mean and a variance of multi-channel convolutional feature data of video segments corresponding to the instance-level regularizer; and
performing the regularization adjustments on multi-channel convolutional feature data of each video segment based on the first reference feature data, to obtain the multi-channel convolutional feature data of each video segment after the regularization adjustments comprises:
performing, for each channel of each video segment, regularization adjustment on channel convolutional feature data of the channel based on the first reference feature data, the mean and the variance that are calculated by the packet-level regularizer, and the mean and the variance that are calculated by the instance-level regularizer corresponding to the video segment, to obtain the multi-channel convolutional feature data of the video segment after regularization adjustment.

8. The method according to claim 7, wherein performing the regularization adjustments on the channel convolutional feature data of the channel based on the first reference feature data, the mean and the variance that are calculated by the packet-level regularizer, and the mean and the variance that are calculated by the instance-level regularizer corresponding to the video segment comprises:
obtaining a weight of the packet-level regularizer and a weight of the instance-level regularizer corresponding to the video segment; and
performing regularization adjustment on the channel convolutional feature data of the channel based on the first reference feature data, the weight of the packet-level regularizer, the mean and the variance that are calculated by the packet-level regularizer, the weight of the instance-level regularizer, and the mean and the variance that are calculated by the instance-level regularizer.

9. The method according to claim 5, wherein obtaining the target feature data of the video to be recognized based on the hidden feature data and the second reference feature data of the video to be recognized comprises:
performing nonlinear transformation on the second reference feature data by using the one-dimensional convolutional network, to obtain transformed feature data; and
performing a convolution operation on the transformed feature data and the hidden feature data of the video to be recognized by using the one-dimensional convolutional network, to obtain the target feature data of the video to be recognized.

10. The method according to claim 1, wherein extracting and aggregating, for each video segment, the features of the face image frames in the video segment by using the 3D convolutional network, to obtain the target feature data of the video segment comprises:
sequentially inputting, for each video segment, the face image frames comprised in the video segment into the 3D convolutional network in sequence; and
extracting and aggregating the features of the face image frames by using the 3D convolutional network, to obtain the target feature data of the video segment.

11. The method according to claim 10, wherein extracting and aggregating the features of the face image frames by using the 3D convolutional network, to obtain the target feature data of the video segment comprises:
sequentially extracting three-dimensional feature data of the face image frames; and
splicing the extracted three-dimensional feature data in sequence, to obtain the target feature data of the video segment.

12. The method according to claim 1, wherein the at least one face image frame corresponds to a continuous facial movement.

13. The method according to claim 1, wherein determining the expression label of the video to be recognized based on the target feature data of the video to be recognized, to obtain the expression label recognition result of the video to be recognized comprises:
recognizing an expression in each video segment in the video to be recognized based on the target feature data of the video to be recognized; and
obtaining a recognition result that the video to be recognized comprises a specified expression or does not comprise the specified expression based on the recognition of the specified expression in the video segment.

14. A computer device, comprising:
a memory for storing a computer program and at least one processor configured to execute the computer program to:
segment a video to be recognized into a plurality of video segments, each video segment comprising at least one face image frame;
extract and aggregate, for each video segment, features of face image frames in the video segment by using a 3D convolutional network, to obtain target feature data of the video segment, the target feature data of the video segment comprising a time series relationship between the face image frames;
aggregate target feature data of the plurality of video segments, to obtain target feature data of the video to be recognized, wherein the target feature data of the video to be recognized include a time series relationship between the plurality of video segments; and
determine an expression label of the video to be recognized based on the target feature data of the video to be recognized, to obtain an expression label recognition result of the video to be recognized.

15. The computer device according to claim 14, wherein to aggregate the target feature data of the plurality of video segments, to obtain the target feature data of the video to be recognized comprises:
perform hidden feature analysis on the target feature data of the plurality of video segments in sequence, to obtain hidden feature data of each video segment, wherein
hidden feature data of each video segment is obtained according to target feature data of the video segment and hidden feature data corresponding to a video segment preceding the video segment in sequence, and is configured according to a time series relationship between the video segment and the video segment preceding the video segment; and
aggregate hidden feature data of the plurality of video segments, to obtain the target feature data of the video to be recognized.

16. The computer device according to claim 15, wherein to perform the hidden feature analysis on the target feature data of the plurality of video segments in sequence, to obtain hidden feature data of each video segment comprises:
sequentially input the target feature data of the plurality of video segments into a recurrent neural network in sequence; and
for each video segment, perform iterative hidden feature analysis on target feature data of the video segment by using the recurrent neural network and based on hidden feature data corresponding to a video segment preceding the video segment in sequence, to obtain hidden feature data of the video segment.

17. The computer device according to claim 15, wherein to aggregate the hidden feature data of the plurality of video segments, to obtain the target feature data of the video to be recognized comprises:
splice the hidden feature data of the plurality of video segments, to obtain hidden feature data of the video to be recognized; and
perform weight adjustment on the hidden feature data of the video to be recognized based on a preset weight adjustment mechanism, to obtain the target feature data of the video to be recognized.

18. The computer device according to claim 14, wherein to extract and aggregate, for each video segment, the features of face image frames in the video segment by using the 3D convolutional network, to obtain the target feature data of the video segment comprises:
sequentially input, for each video segment, the face image frames comprised in the video segment into the 3D convolutional network in sequence; and
extract and aggregate the features of the face image frames by using the 3D convolutional network, to obtain the target feature data of the video segment.

19. The computer device according to claim 14, wherein to determine the expression label of the video to be recognized based on the target feature data of the video to be recognized, to obtain the expression label recognition result of the video to be recognized comprises:
recognize an expression in each video segment in the video to be recognized based on the target feature data of the video to be recognized; and
obtain a recognition result that the video to be recognized comprises the specified expression or does not comprise the specified expression based on the recognition of the specified expression in the video segment.

20. A non-transitory computer-readable medium for storing computer instructions executing executable by a processor to perform a method of dynamic facial recognition by a computer device, said method comprising the steps of:
segmenting a video to be recognized into a plurality of video segments, each video segment comprising at least one face image frame;
extracting and aggregating, for each video segment, features of face image frames in the video segment by using a 3D convolutional network, to obtain target feature data of the video segment, the target feature data of the video segment comprising a time series relationship between the face image frames;
aggregating target feature data of the plurality of video segments, to obtain target feature data of the video to be recognized, wherein the target feature data of the video to be recognized include a time series relationship between the plurality of video segments; and
determining an expression label of the video to be recognized based on the target feature data of the video to be recognized, to obtain an expression label recognition result of the video to be recognized.
